(19) United States
(12) Patent Application Publication
(10) Pub. No.: US 2026/0265478 A1
(43) Pub. Date: Sep. 10, 2026

(54) METHOD FOR PREPARING A POLYURETHANE FOAM

(71) Applicants: UNIVERSITE DE BORDEAUX, BORDEAUX (FR); INSTITUT POLYTECHNIQUE DE BORDEAUX, TALENCE (FR); CENTRE NATIONAL DE LA RECHERCHE SCIENTIFIQUE, PARIS (FR)

(72) Inventors: Yannick LANDAIS, GRADIGNAN (FR); Henri CRAMAIL, SAINTE-TERRE (FR); Ikechukwu Martin OGBU, PESSAC (FR); Thomas VIDIL, BORDEAUX (FR); Frédéric ROBERT, VILLENAVE D'ORNON (FR); Etienne GRAU, BORDEAUX (FR); Quentin JAUSSAUD, PESSAC (FR)

(73) Assignees: UNIVERSITE DE BORDEAUX, BORDEAUX (FR); INSTITUT POLYTECHNIQUE DE BORDEAUX, TALENCE (FR); CENTRE NATIONAL DE LA RECHERCHE SCIENTIFIQUE, PARIS (FR)

(21) Appl. No.: 18/849,427

(22) PCT Filed: Mar. 17, 2023
(86) PCT No.: PCT/FR2023/050378

§ 371 Date: Sep. 20, 2024

(30) Foreign Application Priority Data
Mar. 21, 2022 (FR) 2202487

(51) Int. Cl. C08J 9/08; C08G 71/04

(52) U.S. Cl. CPC C08J 9/08; C08G 71/04; C08J 2203/02

(57) ABSTRACT

The invention relates to a method for preparing a polyurethane foam (I) comprising a) reacting, at a temperature ranging from 60 to 150° C., at least one poly oxamic acid (III) with at least one polyol (II) in the presence of a hypervalent iodine oxidant; b) foaming the polyurethane (I) obtained in step a) in the presence of carbon dioxide. The invention also relates to a polyurethane foam (I) obtained according to the method of the invention.

### TECHNICAL FIELD

The invention relates to a method for preparing a polyurethane foam by (i) reacting at least one poly oxamic acid with at least one polyol, in the presence of an oxidant, followed by (ii) foaming the polyurethane obtained in step (i) using carbon dioxide. The invention also relates to a polyurethane foam obtained using the method according to the invention.

### PRIOR ART

Polymer foams combine the intrinsic lightness of porous materials with low thermal and electrical conductivity, as well as good filtration and energy absorption capabilities. The polymeric nature of these materials also gives them good mechanical resistance. Thanks to its particular properties, polymer foams are used in various fields, such as packaging, electronics, transport, furniture, textiles, aerospace, or construction materials for example.

Usually, polymer foams are prepared by the nucleation of gas bubbles in a polymer or mixture of monomers, followed by a phase change stabilizing the resulting porous structure (vitrification in the case of a thermoplastic polymer, gelation in the case of a thermosetting polymer). The gas bubbles can be generated by a foaming agent, which can be either “physical” (foaming agent released during a phase change), or “chemical” (foaming agent released following a chemical reaction, and in particular thermal decomposition).

In recent years, research in this area has particularly focused on the development of self-foaming systems, which meet the following criteria: (i) the foaming agent is present in the molecular structure of the polymer precursors, (ii) the foaming agent is released as a gas, ideally harmless to the environment, and (iii) no residue remains in the final polymer foam. Self-foaming methods have the advantage that the foaming step is carried out without requiring additional handling, since it is carried out concomitantly with the polymerization step thanks to the in situ production of a foaming agent and does not generate any by-product requiring a subsequent purification step.

Various self-foaming methods have been reported, as detailed in particular in document Monie and al., Materials Science & Engineering R, 145, 2021, 100628. Two main routes have been studied: self-foaming polymers by thermolysis for which the polymers or their precursors include a thermolabile group allowing to generate the foaming agent, and the self-foaming polymers obtained by condensation and polycondensation for which the foaming agent is generated during the synthesis of the polymer by polycondensation.

To date, polyurethane foams are the most produced polymer foams in the world, in particular because of their well-known and mastered preparation method, and access to a wide range of polyurethanes with varied physicochemical properties. Polyurethanes are usually prepared by the polyaddition of polyols to polyisocyanates, according to the reaction first described by Bayer.

Usually, self-foaming methods for preparing polyurethane foam use water. Partial hydrolysis of polyisocyanates during the polymerization reaction results in the formation of unstable carbamic acids, which spontaneously decompose into amine and carbon dioxide. The generated amine reacts with isocyanate to produce urea, and the carbon dioxide generated in situ acts as a foaming agent.

The disadvantage of these methods is that (poly)isocyanates are compounds that are toxic and harmful to the environment, and that their synthesis is carried out from phosgene which is a highly toxic gas. It is therefore necessary to find alternative methods for preparing polyurethane foams, which do not require the storage and handling of (poly)isocyanates or phosgene, in order to limit the risks of environmental pollution and the risks of toxicity for operators.

Carbon dioxide is a foaming agent which has the advantage of not being highly toxic or highly harmful to the environment, of not leaving a by-product in the foam, and of being able to obtain polyurethane foams having physicochemical properties meeting consumer demands. Therefore, it would be desirable to have a self-foaming system capable of releasing carbon dioxide in situ to foam polyurethanes.

The Applicant has therefore sought a self-foaming method for preparing polyurethane foams which is not only satisfactory in terms of conversion rate and physicochemical properties of the foams obtained, but also less toxic and less harmful to the environment than the method commonly used with (poly)isocyanates and polyols in the presence of water. More specifically, the Applicant sought a new route for synthesizing polyurethanes, a reagent of which allows to generate polyisocyanate and carbon dioxide in situ as a foaming agent.

Among the polyisocyanate precursors, the Applicant was interested in poly oxamic acids. Indeed, oxamic acids are known to be stable and easily accessible by the addition of an amine to an oxalic acid derivative. Then, the oxidative decarboxylation of oxamic acid to isocyanate can be carried out either in the presence of a metal catalyst (Minisci and al., J. Chem. Soc, Chem. Commun, 1994, 679, Minisci and al., J. Org. Chem, 1995, 5430-5433), or in the presence of an oxidant, a photocatalyst and a visible light source (Goroba Pawar and al., Chem. Commun. 2018, 54, 9337-9340), or by electrochemical decarboxylation of oxamic acid (Ogbu and al., Chem. Commun. 2020, 56, 12226-12229). Although these methods allow to obtain urethanes from mono oxamic acids with good yields, the synthesis of polyurethane using these methods is limited due to the lack of solubility of poly oxamic acids, and by the heterogeneity and viscosity of the reaction mixture.

There is therefore a need for a method for preparing polyurethane foams that is reproducible, simple to implement, and provides access to a wide range of polyurethane foams. Advantageously, the method does not involve the handling of highly toxic and/or environmentally harmful reagents, such as (poly)isocyanates or phosgene. Advantageously, the reaction generates few by-products, which can be easily eliminated under reduced pressure and/or by heating. Thus, the method according to the invention advantageously allows to easily obtain polyurethane foams. Advantageously, the method is self-foaming.

### DISCLOSURE OF THE INVENTION

The Applicant discovered that it was possible to prepare polyurethane foams by the thermal decomposition of poly oxamic acids in the presence of an oxidant, then generating in situ carbon dioxide and a polyisocyanate, this polyisocyanate being capable of reacting with a polyol to produce a polyurethane whose foaming is carried out using the carbon dioxide produced.

More specifically, the polyurethane foam method according to the invention comprises the following steps:
a) reacting, in the presence of an oxidant and at a temperature ranging from 60 to 150° C., at least one poly oxamic acid of formula (II):

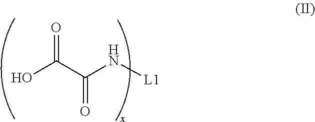

with at least one polyol of formula (III):

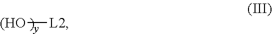

in which
   L1 represents a saturated, linear or branched, cyclic or acyclic hydrocarbon group, in which one or more CH₂ were possibly replaced by O and/or S; or an unsaturated, linear or branched, hydrocarbon group including at least one double bond and/or at least one aromatic ring optionally substituted by one or more alkyl and/or alkoxy groups; or a saturated, linear or branched, cyclic or acyclic hydrocarbon group comprising one or more COOH or polyethylene glycol substituents; or a triester of fatty acids of which one or more CH₂ have optionally been replaced by O and/or S,
   L2 represents a saturated, linear or branched, cyclic or acyclic hydrocarbon group in which one or more CH₂ have optionally been replaced by O; or an unsaturated, linear or branched hydrocarbon group in which one or more CH₂ have optionally been replaced by O and including at least one aromatic ring optionally substituted by one or more alkyl and/or alkoxy groups or at least one aromatic heterocycle; or a triester of fatty acids; or a di, tri or tetra polyester of polyalkylene glycol,
   x represents an integer greater than or equal to 2, and
   y represents an integer greater than or equal to 2,
   it being understood that at least one of x or y is greater than or equal to 3, and
b) foaming the polyurethane (I) obtained in step a) in the presence of carbon dioxide.

During step a), carbon dioxide and at least one polyisocyanate are generated in situ.

The oxidant used in step a) is advantageously a hypervalent iodine oxidant.

The method according to the invention has the advantage of not using a highly toxic and/or environmentally harmful reagent since the polyisocyanate is generated in situ and is not isolated, and does not require the use of phosgene.

The method according to the invention has the advantage of being self-foaming.

The method according to the invention also has the advantage of generating few by-products, the elimination of which from the polyurethane foam produced is easy.

The method according to the invention has the advantage of providing access to a wide range of polyurethane foams, of very varied chemical structure and therefore of varied physicochemical properties. Indeed, poly oxamic acids are prepared from polyamines and oxalic acid derivatives. Their synthesis is easy, and provides access to a wide variety of poly oxamic acids thanks to the wide choice of accessible polyamines.

The method according to the invention has the advantage of being reproducible and easy to implement since the operating conditions are simple.

The method according to the invention further has any of the following characteristics, or a combination thereof:
the carbon dioxide used for foaming in step b) is entirely generated in step a);
steps a) and b) are carried out concomitantly;
L1 is selected from the following groups:

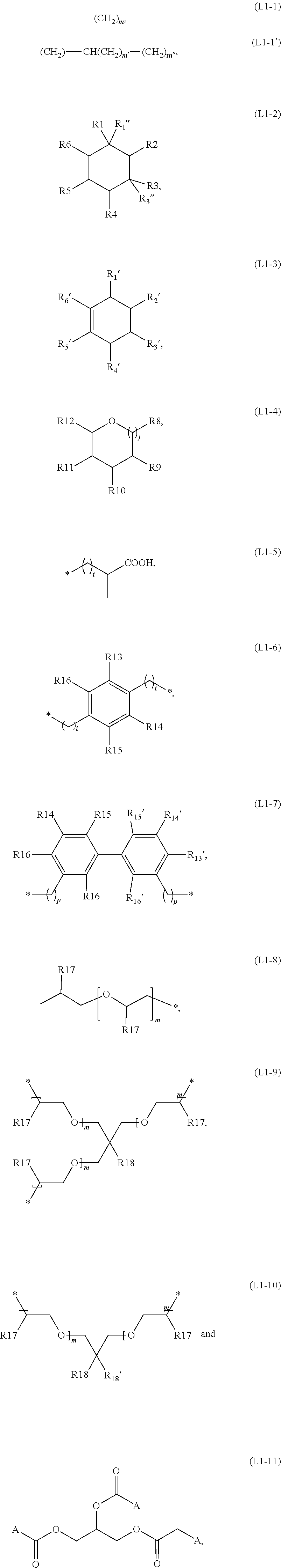

with:
   R1, R1′, R1″, R2, R2′, R3, R3′, R3″, R4, R4′, R5, R5′, R6 and R6′ identical or different and independently representing H, (CH₂)ᵢ, CH₃, CH₃—(CH₂)ᵢ, CH₃O, CH₃—(CH₂)ᵢO, CH₃S, CH₃—(CH₂)ᵢS, (CH₂)ᵢS, (CH₂)ᵢCH(CH₃)S or CH₃—(CH₂)ᵢCH(CH₃)S,
   R2 and R3 which can together represent a CH(R7a)-CH(R7b)-CH(R7c)-CH(R7d) group with R7a, R7b, R7c and R7d identical or different and independently representing H, (CH₂)ᵢ, CH₃, CH₃—(CH₂)ᵢ, CH₃O or CH₃—(CH₂)ᵢO,
   it being understood that at least two groups among R1, R1″, R2, R3, R3″, R4, R5 and R6 and at least two groups among R1′, R2′, R3′, R4′, R5′ and R6′ represent (CH₂)ᵢ,
   R8, R9, R10, R11 and R12 identical or different and independently representing H, (CH₂)ᵢ, CH₃, CH₃—(CH₂)ᵢ, O(CH₂)ᵢ, CH₃O or CH₃—(CH₂)ᵢO,
   R11 and R12 which together can represent a O—CH(R7a)-CH(R7b)-CH (R7c)-(CH(R7d))ⱼ group, it being understood that at least two groups among R7a, R7b, R7c, R7d, R8, R9, R10, R11 and R12 represent (CH₂)ᵢ or O(CH₂)ᵢ,
   R13, R14, R15, R16, R13′, R14′, R15′ and R16′ identical or different and independently representing H, CH₃(CH₂)ₖ or CH₃(CH₂)ₖO,
   R17 representing H or CH₃(CH₂)ₖ′
   R18 and R18′ independently representing H, CH₃(CH₂)ₖ, CH₂[OCH₂CH₂]ₘOH, or CH₂[OCH₂CHCH₃]ₘNHCOCOOH,
   A representing a hydrocarbon, linear or branched chain including from 12 to 30 carbon atoms, and of which one or more CH₂ have been replaced by S,
   i representing an integer ranging from 0 to 20,
   j representing 0 or 1,
   k representing an integer ranging from 0 to 6,
   m, m′ and m″ being identical or different and independently representing an integer ranging from 1 to 500, and
   p representing an integer ranging from 1 to 6;
the at least one poly oxamic acid is such that x is equal to 2 or 3;
the at least one poly oxamic acid is such that L1 is selected from:

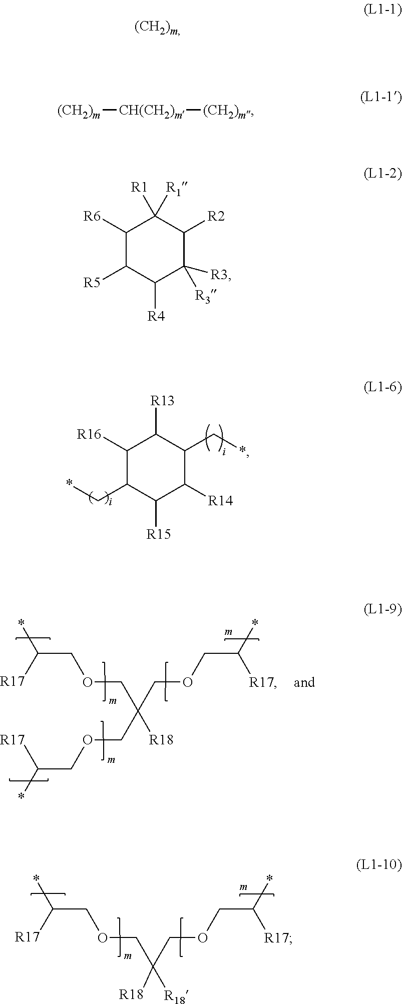

the at least one poly oxamic acid is such that L1 is selected from: (CH₂)ₘ (L1-1) and

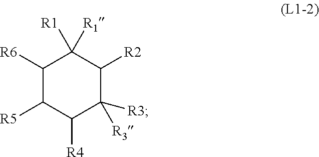

the at least one polyol is such that L2 is selected from the following groups:

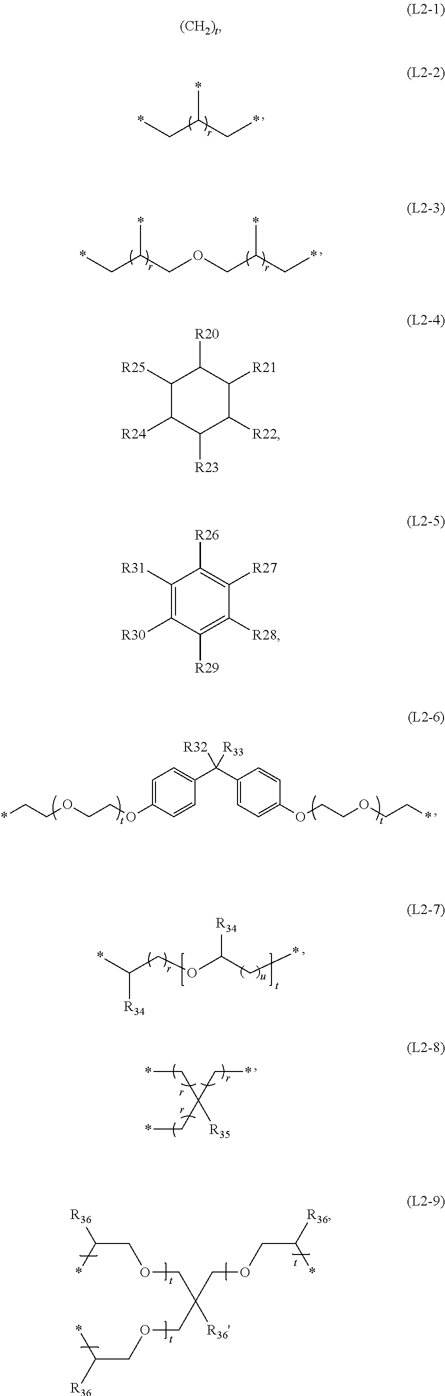

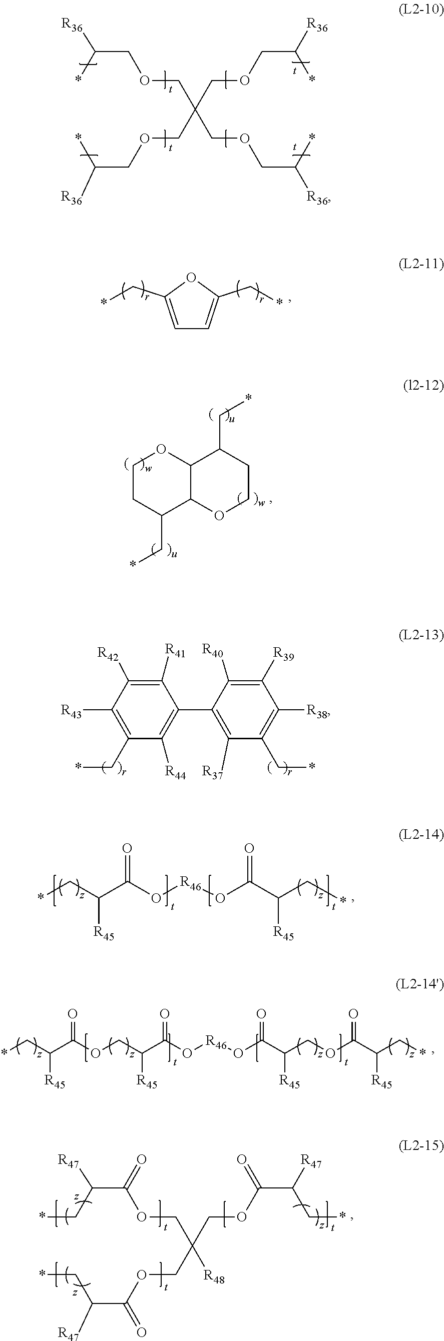

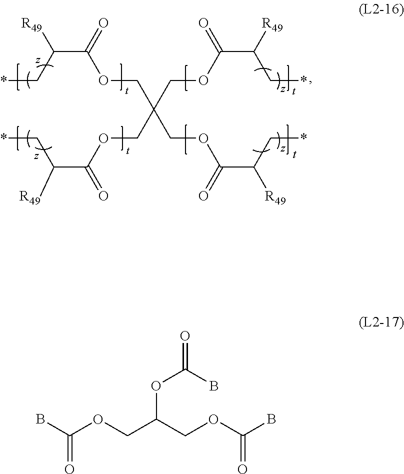

with:
   R20, R21, R22, R23, R24 and R25 being identical or different and independently representing H, —(CH₂)ₛ, CH₃ or CH₃—(CH₂)ₛ,
   R21 and R22 which can together represent a group CH(R22a)-CH(R22b)-CH(R22c)-CH(R22d) with R22a, R22b, R22c and R22d identical or different and independently representing H, (CH₂)ₛ, CH₃ or CH₃—(CH₂)ₛ,
   it being understood that at least two groups among R20, R21, R22, R22a, R22b, R22c and R22d, R23, R24 and R25 represent (CH₂)ₛ,
   R26, R27, R28, R29, R30 and R31 being identical or different and independently representing H, (CH₂)ₛ, CH₃, CH₃—(CH₂)ₛ, O(CH₂)ₛ, CH₃O or CH₃—(CH₂)ₛO, it being understood that at least two groups among R26, R27, R28, R29, R30 and R31 represent (CH₂)ₛ or O(CH₂)ₛ,
   R32, R33, R34, R36, R36′, R45, R47, R48 and R49 independently representing H, CH₃ or CH₃(CH₂)ᵣ,
   R35 representing CH₃, CH₃(CH₂)ᵣ or HO(CH₂)ᵣ,
   R37, R38, R39, R40, R41, R42, R43 and R44 being identical or different and independently representing H, (CH₂)ₛ, CH₃, CH₃—(CH₂)ₛ, O(CH₂)ₛ, CH₃O or CH₃—(CH₂)ₛO,
   R46 representing (CH₂)ᵣ, benzylene or cyclohexylene,
   B representing a linear or branched hydrocarbon chain including from 12 to 30 carbon atoms, and including at least one double bond,
   s representing an integer ranging from 1 to 18,
   r representing an integer ranging from 1 to 6,
   t representing an integer ranging from 1 to 500,
   u representing 0, 1, 2 or 3,
   w representing 0 or 1,
   z representing an integer ranging from 0 to 4;
the at least one polyol is such that y is equal to 3 or 4;
the at least one polyol is such that L2 is selected from:

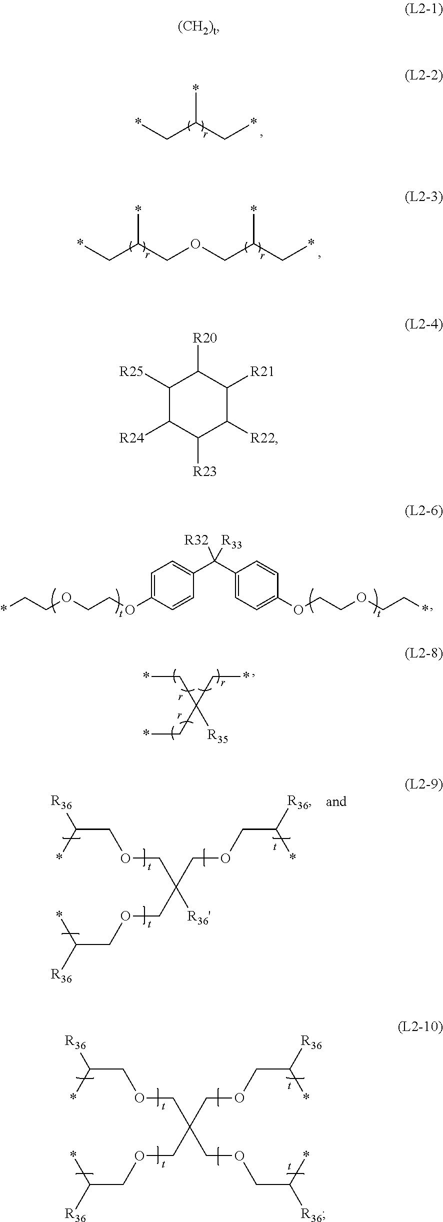

the at least one polyol is such that L2 represents:

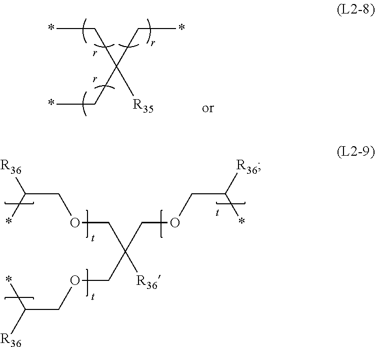

the oxidant is a hypervalent iodine compound, preferably selected from bis(trifluoroacetoxy)iodobenzene, bis(acetoxy)iodobenzene, poly[4-(diacetoxyiodo)styrene], hydroxybenziodoxole, and acetoxybenziodoxole;
the method comprises a step c), subsequent to step b), of purifying the polyurethane foam (I), preferably by heating and/or under reduced pressure;
the reaction between the at least one poly oxamic acid and the at least one polyol is carried out in the presence of a non-ionic surfactant (IV);
the surfactant (IV) is selected from:

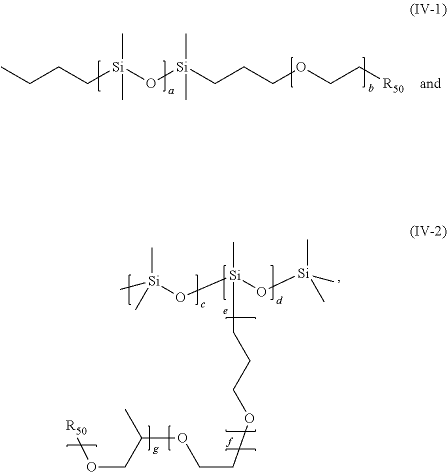

with:
   R50 representing OH, CH₃—(CH₂)ₕO or O(CO)(CH₂)ₕCH₃ with h representing an integer ranging from 0 to 3,
   a, b, c, d, e, f and g being identical or different and independently representing an integer ranging from 0 to 500;
the method is carried out in a closed reactor and under reduced pressure;
the method is carried out in an open reactor; and
the polyurethane foam (I) is purified by a heating step and/or under reduced pressure.

The invention also relates to a polyurethane foam obtained using the method according to the invention.

Advantageously, this polyurethane foam has physicochemical properties of the same order of magnitude and comparable to those obtained by the method using polyisocyanates, polyols and water.

The polyurethane foams according to the invention also have any of the following characteristics, or a combination thereof:
the density of the polyurethane foam (I) ranges from 10 to 1000 kg·m⁻³, preferably from 100 to 300 kg·m⁻³; and
the polyurethane foam has cells whose diameter is comprised between 0.1 mm and 2 mm, preferably between 0.2 mm and 1.5 mm, the diameter being measured using a scanning electron microscope at 50 Pa and 7.00 kV on sections transverse to the direction of expansion of the material.

### BRIEF DESCRIPTION OF THE DRAWINGS

FIG. 1 is a photograph of PU2 foam.

FIG. 2 is an image of the PU2 foam observed under a scanning electron microscope (FEI QUANTA, 7 kV).

### DESCRIPTION OF EMBODIMENTS

The invention relates to a self-foaming method for preparing polyurethane foams (I). The method according to the invention comprises the following steps:
a) reacting, in the presence of an oxidant and at a temperature ranging from 60° C. to 150° C., at least one poly oxamic acid of formula (II):

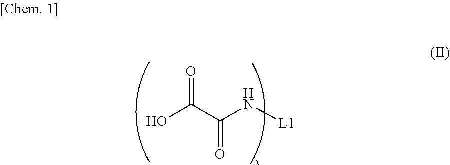

with at least one polyol of formula (III):

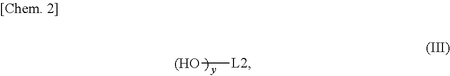

and
b) foaming the polyurethane (I) obtained in step a) in the presence of carbon dioxide.

Polyurethane (I) is advantageously thermosetting.

In the context of the invention, a “poly oxamic acid” or “multi oxamic acid” is a compound comprising several oxamic acid functions. Oxamic acid function means a group —N(H)—C(O)—COOH.

Preferably, the reaction temperature in step a) ranges from 80° C. to 130° C. Preferably, the reaction is carried out at atmospheric pressure.

The method according to the invention can be carried out either in an open reactor or in a closed reactor.

In the context of the invention, x and y are both greater than or equal to two, and at least one of x or y is greater than or equal to 3. Thus, the polyurethane (I) is crosslinked.

Polyurethane (I) is prepared from one or more poly oxamic acids (II). According to a particular embodiment, the polyurethane foam (I) is prepared from a single poly oxamic acid (II).

The poly oxamic acid(s) of formula (II) include at least two oxamic acid functions, preferably two, three or four, and in particular two or three. In other words, x represents an integer greater than or equal to 2, preferably equal to 2, 3 or 4, and in particular equal to 2 or 3.

The poly oxamic acid(s) (II) is such that L1 represents a saturated, linear or branched, cyclic or acyclic hydrocarbon group in which one or more CH₂ have optionally been replaced by O and/or S; or an unsaturated, linear or branched hydrocarbon group including at least one double bond and/or at least one aromatic ring optionally substituted by one or more alkyl and/or alkoxy groups; or a saturated, linear or branched, cyclic or acyclic hydrocarbon group comprising one or more COOH or polyethylene glycol substituents; or a triester of fatty acids of which one or more CH₂ have optionally been replaced by O and/or S.

In the context of the invention, a “hydrocarbon group” designates, unless otherwise specified, a linear or branched, cyclic or acyclic, saturated or unsaturated chain and including only carbon and hydrogen atoms. A hydrocarbon group can therefore designate an alkyl group or an alkylene group in particular.

“Alkylene” group means a divalent alkyl group. Unless otherwise specified, an alkylene group can be branched or linear, cyclic or acyclic.

“Alkylene glycol” group means a divalent alkyl group substituted by two OH groups. As examples of alkylene glycol groups, mention may be made of ethylene glycol and propylene glycol groups in particular.

“Alkoxy” and “aryloxy”, mean an —O-alkyl and —O-aryl group, respectively.

“Fatty acid” means an aliphatic carboxylic acid whose hydrocarbon chain comprises from 4 to 36 carbon atoms, and typically from 6 to 28 carbon atoms.

According to a preferred embodiment, L1 is selected from the following groups:

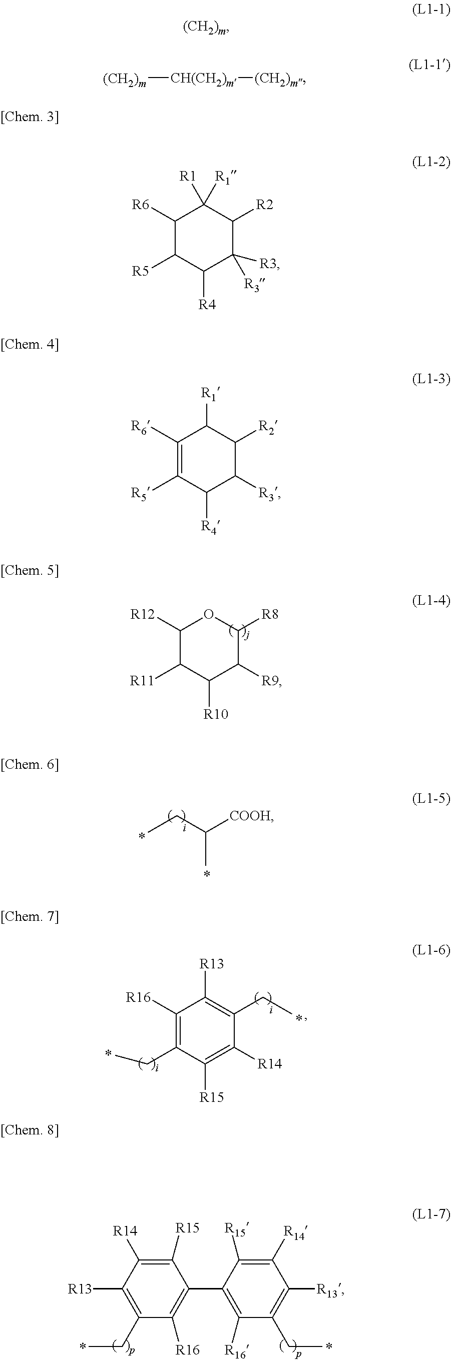

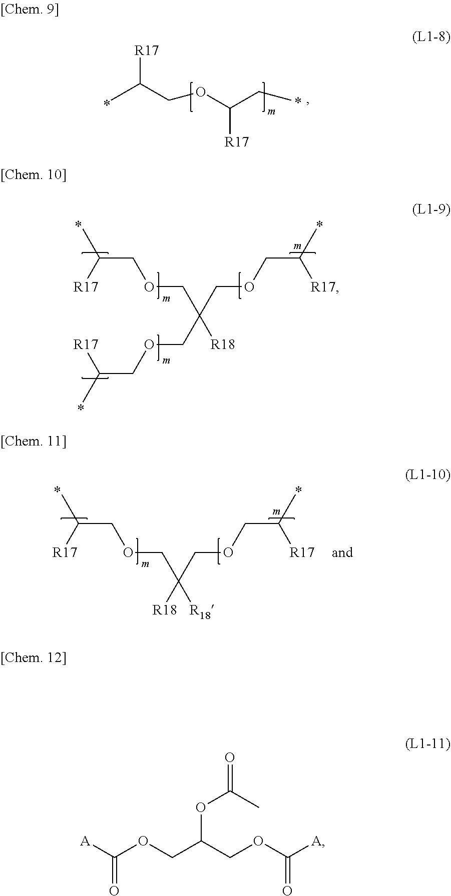

with:
   R1, R1′, R1″, R2, R2′, R3, R3′, R3″, R4, R4′, R5, R5′, R6 and R6′ identical or different and independently representing H, (CH₂)ᵢ, CH₃, CH₃—(CH₂)ᵢ, CH₃O, CH₃—(CH₂)ᵢO, CH₃S, CH₃—(CH₂)ᵢS, (CH₂)ᵢS, (CH₂)ᵢCH(CH₃)S or CH₃—(CH₂)ᵢCH(CH₃)S,
   R2 and R3 which can together represent a CH(R7a)-CH(R7b)-CH(R7c)-CH(R7d) group with R7a, R7b, R7c and R7d identical or different and independently representing H, (CH₂)ᵢ, CH₃, CH₃—(CH₂)ᵢ, CH₃O or CH₃—(CH₂)ᵢO,
   it being understood that at least two groups among R1, R1″, R2, R3, R3″, R4, R5 and R6 and at least two groups among R1′, R2′, R3′, R4′, R5′ and R6′ represent (CH₂)ᵢ,
   R8, R9, R10, R11 and R12 identical or different and independently representing H, (CH₂)ᵢ, CH₃, CH₃—(CH₂)ᵢ, O(CH₂)ᵢ, CH₃O or CH₃—(CH₂)ᵢO,
   R11 and R12 which together can represent a O—CH(R7a)-CH(R7b)-CH(R7c)-(CH(R7d))ⱼ group, it being understood that at least two groups among R7a, R7b, R7c, R7d, R8, R9, R10, R11 and R12 represent (CH₂)ᵢ or O(CH₂)ᵢ,
   R13, R14, R15, R16, R13′, R14′, R15′ and R16′ identical or different and independently representing H, CH₃(CH₂)ₖ or CH₃(CH₂)ₖO,
   R17 representing H or CH₃(CH₂)ₖ,
   R18 and R18′ independently representing H, CH₃(CH₂)ₖ, CH₂[OCH₂CH₂]ₘOH, or CH₂[OCH₂CHCH₃]ₘNHCOCOOH,
   A representing a hydrocarbon, linear or branched chain including from 12 to 30 carbon atoms, and of which one or several CH₂ have been replaced by S,
   i representing an integer ranging from 0 to 20,
   j representing 0 or 1,
   k representing an integer ranging from 0 to 6,
   m, m′ and m″ being identical or different and independently representing an integer ranging from 1 to 500, and
   p representing an integer ranging from 1 to 6.

According to one embodiment, the at least one poly oxamic acid (II) is such that L1 represents L1-1 or L1-1′ with m, m′ and m″ being identical or different and independently representing an integer preferably ranging from 1 to 20, preferably from 1 to 14, and preferably from 6 to 10. According to this embodiment, x is preferably equal to 2 or 3, and advantageously is equal to 2 when L1 represents L1-1 or equal to 3 when L1 represents L1-1′. As examples according to this embodiment, the poly oxamic acid (II) can be such that x=2, L1 representing (CH₂)ₘ with i=6 or i=10.

According to one embodiment, the at least one poly oxamic acid (II) is such that L1 represents L1-2.

According to a first preferred variant of this embodiment, L1-2 is such that R1 represents (CH₂)ᵢ, CH₃ or CH₃—(CH₂)ᵢ, R1″ and R3″ represent H, CH₃ or CH₃—(CH₂)ᵢ, R2 represents H, (CH₂)ᵢ, (CH₂)ᵢS, R3 represents H, (CH₂)ᵢ, CH₃ or CH₃—(CH₂)ᵢ, R4 represents H, CH₃, CH₃—(CH₂)ᵢ or (CH₂)ᵢCH(CH₃)S, R5 represents H or (CH₂)ᵢ and R6 represents H. As examples of poly oxamic acids (II) according to this embodiment, mention can be made of the following poly oxamic acids:

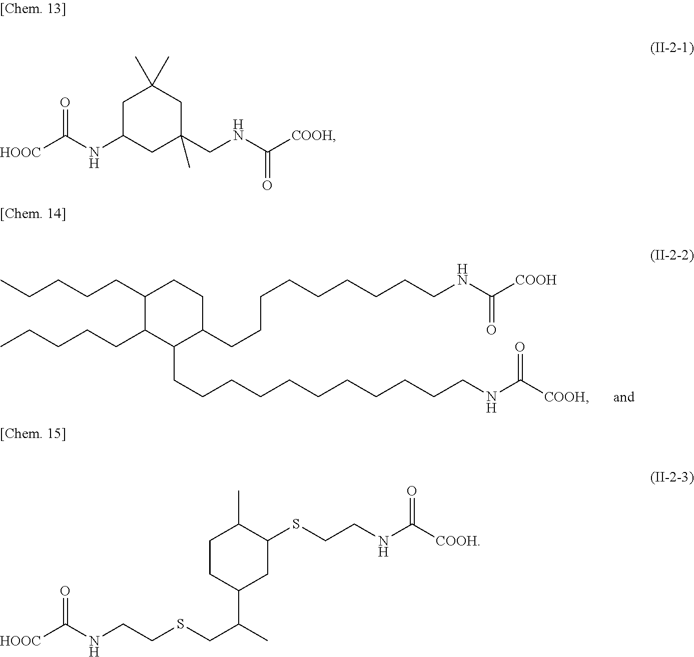 [SMILES: CC1(C)CC(NC(=O)C(=O)O)CC(C)(CNC(=O)C(=O)O)C1 ; CCCCCC1CCC(CCCCCCCCCNC(=O)C(=O)O)C(CCCCCCCCCCCNC(=O)C(=O)O)C1CCCCC ; CC(CSCCNC(=O)C(=O)O)C1CCC(C)C(SCCNC(=O)C(=O)O)C1]

According to a second preferred variant of this embodiment, L1-2 is such that R1, R1″, R2, R3, R3″, R4, R5 and R6 are identical or different and independently represent H, (CH₂)ᵢ, CH₃ or CH₃—(CH₂)ᵢ. According to this embodiment, x is preferably equal to 2. As examples of poly oxamic acids (II) according to this embodiment, mention can be made of the following poly oxamic acids:

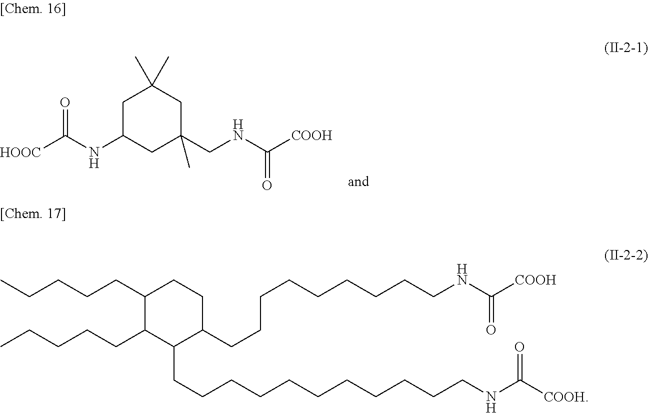 [SMILES: CC1(C)CC(NC(=O)C(=O)O)CC(C)(CNC(=O)C(=O)O)C1 ; CCCCCC1CCC(CCCCCCCCCNC(=O)C(=O)O)C(CCCCCCCCCCCNC(=O)C(=O)O)C1CCCCC]

According to a third preferred embodiment, L1-2 is such that R1 and R6 represent (CH₂)ᵢ, R4 and R5 represent CH₃ or CH₃—(CH₂)ᵢ, and R2 and R3 together represent a CH(R7a)-CH(R7b)-CH(R7c)-CH(R7d) group with R7a, R7b, R7c and R7d identical or different and independently representing H, (CH₂)ᵢ, CH₃, CH₃—(CH₂)ᵢ, CH₃O or CH₃—(CH₂)ᵢO, and preferably H, (CH₂)ᵢ, CH₃, or CH₃—(CH₂)ᵢ. As an example of poly oxamic acid (II) according to this embodiment, mention can be made of the following poly oxamic acid:

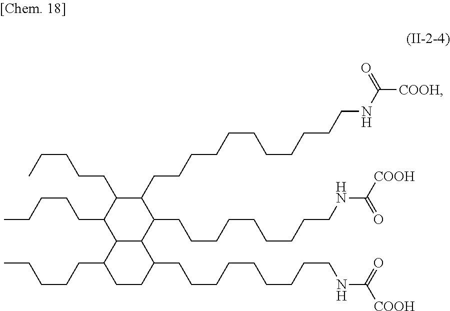 [SMILES: CCCCCC1CCC(CCCCCCCCCNC(=O)C(=O)O)C2C(CCCCCCCCCNC(=O)C(=O)O)C(CCCCCCCCCCCNC(=O)C(=O)O)C(CCCCC)C(CCCCC)C12]

According to one embodiment, the at least one poly oxamic acid (II) is such is that L1 represents L1-3. According to this embodiment, R1′, R2′, R3′, R4′, R5′ and R6′ are identical or different and preferably independently represent H, (CH₂)ᵢ, CH₃ or CH₃—(CH₂)ᵢ. As an example of poly oxamic acid (II) according to this embodiment, mention can be made of the following poly oxamic acid:

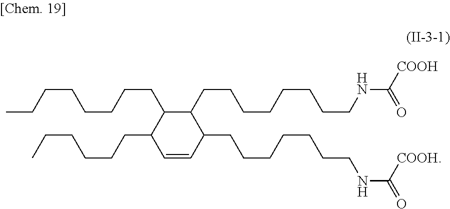 [SMILES: CCCCCCCCC1C(CCCCCC)C=CC(CCCCCCCNC(=O)C(=O)O)C1CCCCCCCCNC(=O)C(=O)O]

According to one embodiment, the at least one poly oxamic acid (II) is such that L1 represents L1-4. According to this embodiment, j preferably represents 0. Preferably according to this embodiment, R11 and R12 together represent a O—CH(R7a)-CH(R7b)-CH(R7c)-(CH(R7d))ⱼ group, with R7a, R7b, R7c and R7d as defined above and j representing 0 or 1. Preferably, R8, R9 and R10 represent H. As an example of poly oxamic acid (II) according to this embodiment, mention may be made of the following poly oxamic acid:

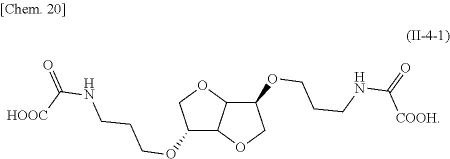 [SMILES: O=C(O)C(=O)NCCCO[C@H]1COC2C1OC[C@H]2OCCCNC(=O)C(=O)O]

According to one embodiment, the at least one poly oxamic acid (II) is such that L1 represents L1-5. According to this embodiment, i is advantageously an integer ranging from 1 to 10, preferably ranging from 1 to 6, and in particular equal to 4.

According to one embodiment, the at least one poly oxamic acid (II) is such that L1 represents L1-6. According to this embodiment, R13, R14, R15 and R16 are preferably identical or different and independently represent H or CH₃—(CH₂)ₖ. According to this embodiment, i is an integer preferably ranging from 1 to 10, and in particular from 1 to 4. As an example of poly oxamic acid (II) according to this embodiment, mention may be made of poly oxamic acid for which R13, R14, R15 and R16 each represent H and i is equal to 1.

According to one embodiment, the at least one poly oxamic acid (II) is such that L1 represents L1-7. According to this embodiment, R13, R14, R15, R16, R13′, R14′, R15′ and R16′ identical or different and preferably independently representing H, CH₃O or CH₃(CH₂)ₖO. Preferably, R13, R13′, R16 and R16′ represent H. According to this embodiment, p preferably represents an integer ranging from 1 to 4. As an example of poly oxamic acid (II) according to this embodiment, mention can be made of the following poly oxamic acid:

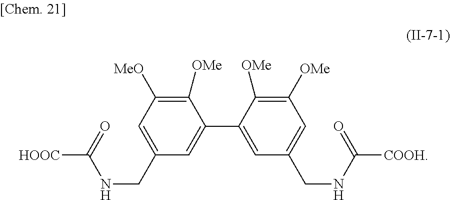 [SMILES: COc1cc(CNC(=O)C(=O)O)cc(-c2cc(CNC(=O)C(=O)O)cc(OC)c2OC)c1OC]

According to one embodiment, the at least one poly oxamic acid (II) is such that L1 represents L1-8. According to this embodiment, R17 represents H or CH₃(CH₂)ₖ, with k preferably ranging from 0 to 4, and in particular from 0 to 2. As examples of poly oxamic acids (II) according to this embodiment, mention may be made of the following poly oxamic acids:

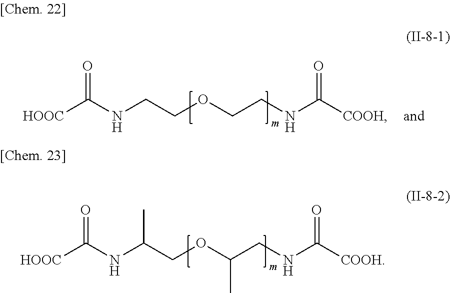

According to one embodiment, the at least one poly oxamic acid (II) is such that L1 represents L1-9. According to this embodiment, R17 represents H or CH₃(CH₂)ₖ with k being an integer preferably ranging from 0 to 4, more preferably from 0 to 2, and in particular being equal to 0. According to this embodiment, R18 preferably represents H or CH₃(CH₂)ₖ with k ranging from 0 to 4, preferably from 0 to 2, and in particular being equal to 1, or R18 represents CH₂[OCH₂CHCH₃]ₘNHCOCOOH or CH₂[OCH₂CH₂]ₘOH. As examples of poly oxamic acids (II) according to this embodiment, mention can be made of the following poly oxamic acids:

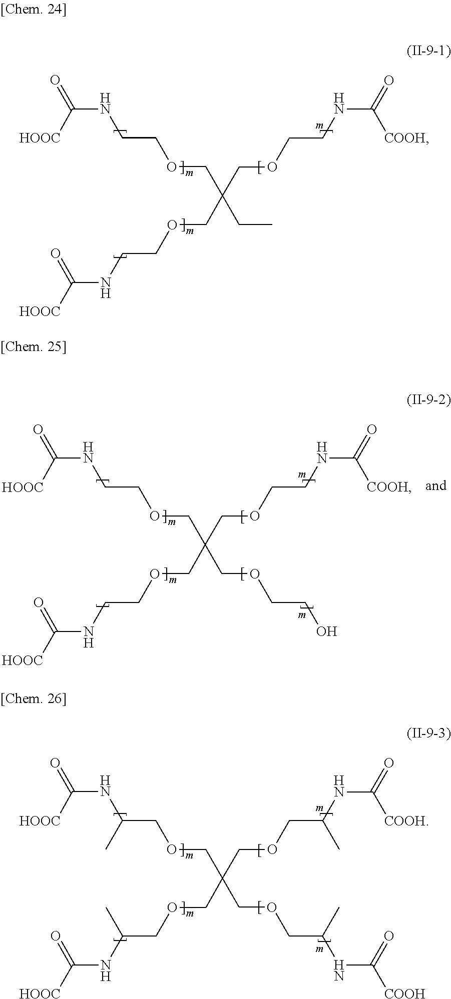 [SMILES: CCC(COCCNC(=O)C(=O)O)(COCCNC(=O)C(=O)O)COCCNC(=O)C(=O)O ; O=C(O)C(=O)NCCOCC(COCCO)(COCCNC(=O)C(=O)O)COCCNC(=O)C(=O)O ; CC(COCC(COCC(C)NC(=O)C(=O)O)(COCC(C)NC(=O)C(=O)O)COCC(C)NC(=O)C(=O)O)NC(=O)C(=O)O]

According to one embodiment, the at least one poly oxamic acid (II) is such that L1 represents L1-10. According to this embodiment, R17 represents H or CH₃(CH₂)ₖ with k being an integer preferably ranging from 0 to 4, more preferably from 0 to 2, and in particular being equal to 0. According to this embodiment, R18 preferably represents H or CH₃(CH₂)ₖ with k ranging from 0 to 4, preferably from 0 to 2, and in particular being equal to 1. According to this embodiment, R18′ preferably represents H, CH₃(CH₂)ₖ, or CH₂[OCH₂CH₂]ₘOH. As an example of poly oxamic acid (II) according to this embodiment, mention can be made of the following poly oxamic acid:

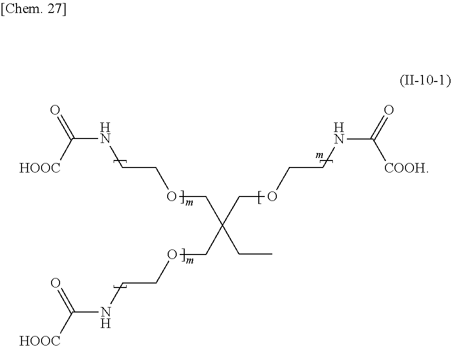 [SMILES: CCC(COCCNC(=O)C(=O)O)(COCCNC(=O)C(=O)O)COCCNC(=O)C(=O)O]

According to one embodiment, the at least one poly oxamic acid is such that L1 represents L1-11. According to this embodiment, L1-11 may represent a triester of fatty acids optionally functionalized with cysteamine. In this case, the fatty acids may in particular be a saturated fatty acid such as stearic acid, or an unsaturated fatty acid functionalized with cysteamine at the double bond(s). Among the unsaturated fatty acids, mention may in particular be made of oleic acid, palmitoleic acid, erucic acid and linoleic acid.

According to a preferred embodiment of the invention, the at least one poly oxamic acid (II) is such that the group L1 is selected from the groups L1-1, L1-1′, L1-2, L1-6, L1-9 and L1-10, as defined above, and preferably from L1-1 and L1-2.

The polyurethane (I) is prepared from at least one polyol of formula (III). According to a particular embodiment, the polyurethane is prepared from a single polyol (III). According to another particular embodiment, the polyurethane (III) is prepared from two polyols (III).

The polyol(s) (III) include at least two hydroxyl functions, preferably two, three, four, five or six, and in particular two, three or four or even three or four. In other words, y represents an integer greater than or equal to 2, preferably equal to 2, 3, 4, 5 or 6, and in particular 2, 3 or 4, or even 3 or 4.

The polyol(s) is such that L2 represents a saturated, linear or branched, cyclic or acyclic hydrocarbon group in which one or more CH₂ have optionally been replaced by O; or an unsaturated, linear or branched hydrocarbon group in which one or more CH₂ have optionally been replaced by O and including at least one aromatic ring optionally substituted by one or more alkyl and/or alkoxy groups or at least one aromatic heterocycle; or a triester of fatty acids; or a di, tri or tetra polyalkylene glycol polyester.

According to a preferred embodiment, L2 is selected from the following groups:

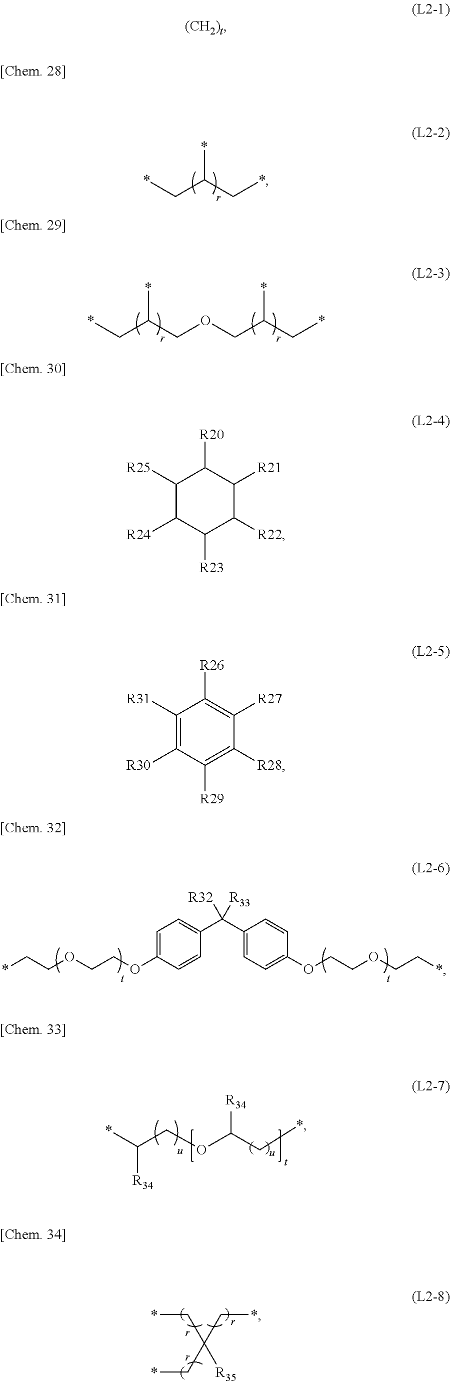

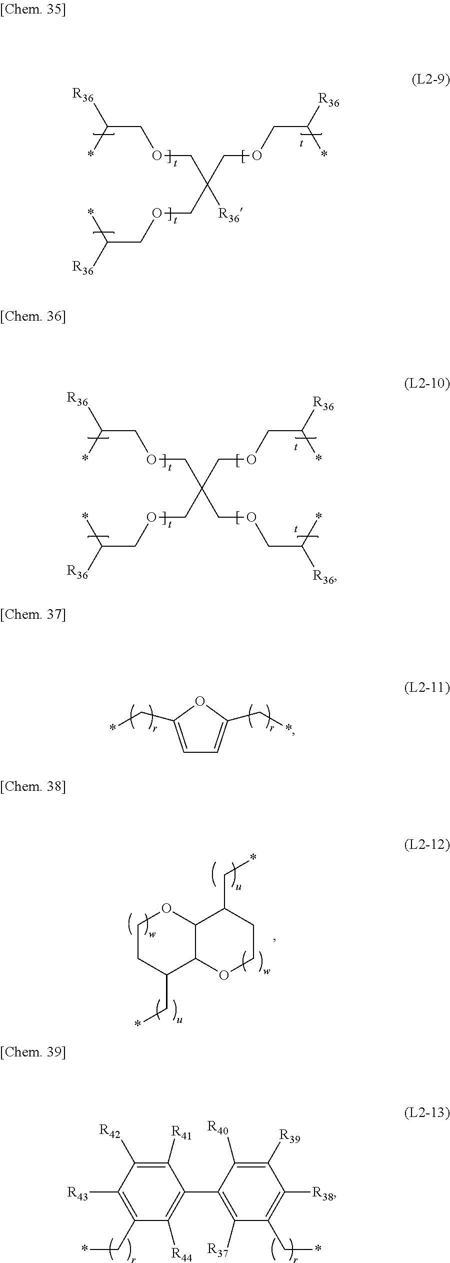

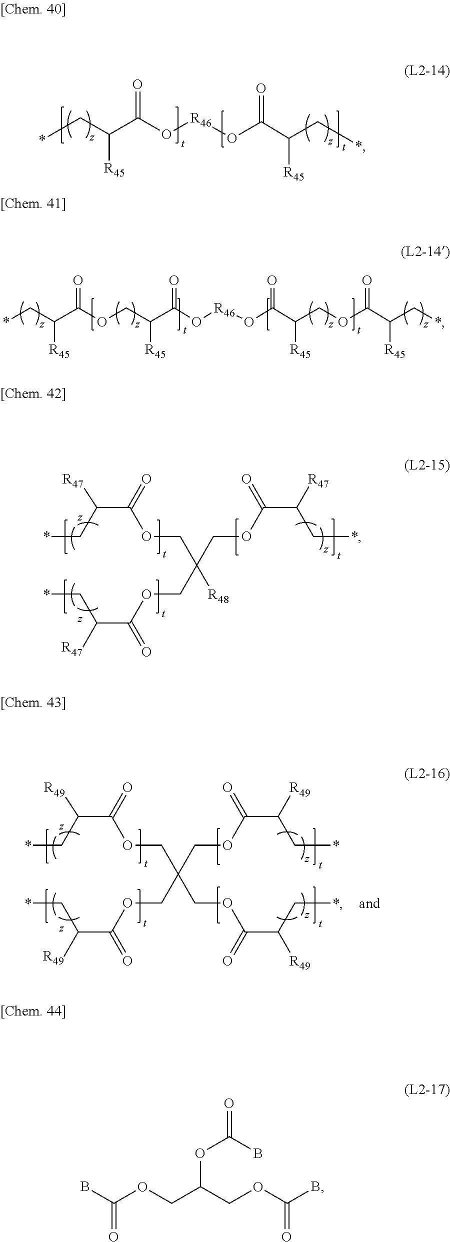

with:
   R20, R21, R22, R23, R24 and R25 being identical or different and independently representing H, (CH₂)ₛ, CH₃ or CH₃—(CH₂)ₛ,
   R21 and R22 which can together represent a group CH(R22a)-CH(R22b)-CH(R22c)-CH(R22d) with R22a, R22b, R22c and R22d identical or different and independently representing H, (CH₂)ₛ, CH₃ or CH₃—(CH₂)ₛ,
   it being understood that at least two groups among R20, R21, R22, R22a, R22b, R22c and R22d, R23, R24 and R25 represent (CH₂)ₛ,
   R26, R27, R28, R29, R30 and R31 being identical or different and independently representing H, (CH₂)ₛ, CH₃, CH₃—(CH₂)ₛ, O(CH₂)ₛ, CH₃O or CH₃—(CH₂)ₛO, it being understood that at least two groups among R26, R27, R28, R29, R30 and R31 represent (CH₂)ₛ or O(CH₂)ₛ,
   R32, R33, R34, R36, R36′, R45, R47, R48 and R49 independently representing H, CH₃ or CH₃(CH₂)ᵣ,
   R35 representing CH₃, CH₃(CH₂)ᵣ or HO(CH₂)ᵣ,
   R37, R38, R39, R40, R41, R42, R43 and R44 being identical or different and independently representing H, (CH₂)ₛ, CH₃, CH₃—(CH₂)ₛ, O(CH₂)ₛ, CH₃O or CH₃—(CH₂)ₛO,
   R46 representing (CH₂)ᵣ, benzylene or cyclohexylene,
   B representing a hydrocarbon, linear or branched chain including from 12 to 30 carbon atoms, and including at least one double bond,
   s representing an integer ranging from 1 to 18,
   r representing an integer ranging from 1 to 6,
   t representing an integer ranging from 1 to 500,
   u representing 0, 1, 2 or 3,
   w representing 0 or 1,
   z representing an integer ranging from 0 to 4.

According to one embodiment, the at least one polyol (III) is such that L2 represents L2-1. According to this embodiment, t represents an integer preferably ranging from 1 to 18, preferably from 1 to 12, and preferably from 1 to 6. As an example of polyol (III) according to this embodiment, mention can be made of ethylene glycol OH—CH₂—CH₂—OH (that is to say t=2).

According to one embodiment, the at least one polyol (III) is such that L2 represents L2-2. According to this embodiment, r is an integer preferably ranging from 1 to 4, and preferably is equal to 1, 2 or 4. As examples of polyols (III) according to this embodiment, mention can be made of the following polyols:

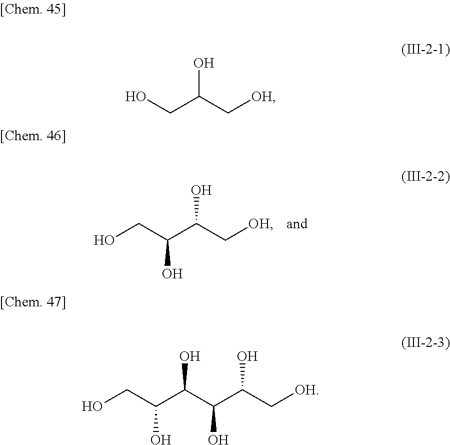 [SMILES: OCC(O)CO ; OC[C@@H](O)[C@@H](O)CO ; OC[C@@H](O)[C@@H](O)[C@H](O)[C@H](O)CO]

According to one embodiment, the at least one polyol (III) is such that L2 represents L2-3. According to this embodiment, r is an integer preferably ranging from 1 to 4, and preferably is equal to 1, 2 or 3. As an example of polyol (III) according to this embodiment, mention can be made of the following polyol:

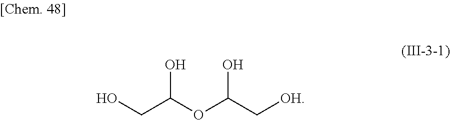

According to one embodiment, the at least one polyol (III) is such that L2 represents L2-4. According to a first preferred variant according to this embodiment, R20 and R21 are identical or different and represent (CH₂)ₛ, and R22, R23, R24 and R25 are identical or different and independently represent H, CH₃ or CH₃—(CH₂)ₛ. As examples of polyols (III) according to this embodiment, mention can be made of the following polyol:

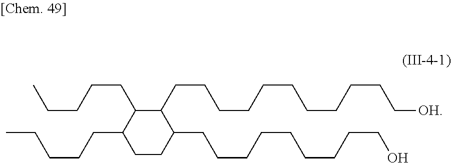 [SMILES: CCCCCC1CCC(CCCCCCCCCO)C(CCCCCCCCCCCO)C1CCCCC]

According to a second preferred variant according to this embodiment, R20, R23, R24 and R25 are identical or different and preferably independently represent H, (CH₂)ₛ, CH₃ or CH₃—(CH₂)ₛ, and R21 and R22 together represent a group CH(R22a)-CH(R22b)-CH(R22c)-CH(R22d) with R22a, R22b, R22c and R22d identical or different and independently representing H, (CH₂)ₛ, CH₃ or CH₃—(CH₂)ₛ. As examples of polyols (III) according to this embodiment, mention can be made of the following polyol:

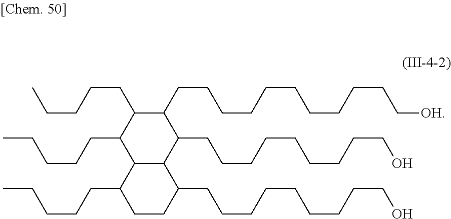 [SMILES: CCCCCC1CCC(CCCCCCCCCO)C2C(CCCCCCCCCO)C(CCCCCCCCCCCO)C(CCCCC)C(CCCCC)C12]

According to one embodiment, the at least one polyol (III) is such that L2 represents L2-5. Preferably according to this embodiment, R26, R27, R28, R29, R30 and R31 independently of each other represent H, (CH₂)ₛ, or O(CH₂)ₛ. According to this embodiment, s preferably represents an integer ranging from 1 to 12, preferably from 1 to 6. As examples of polyols (III) according to this embodiment, mention can be made of the following polyols:

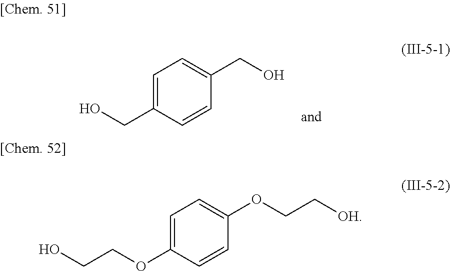 [SMILES: OCc1ccc(CO)cc1 ; OCCOc1ccc(OCCO)cc1]

According to one embodiment, the at least one polyol (III) is such that L2 represents L2-6. According to this embodiment, R32 and R33 preferably independently represent H, CH₃ or CH₃(CH₂)ᵣ with r representing an integer ranging from 1 to 4. As an example of polyol (III) according to this embodiment, mention can be made of the following polyol:

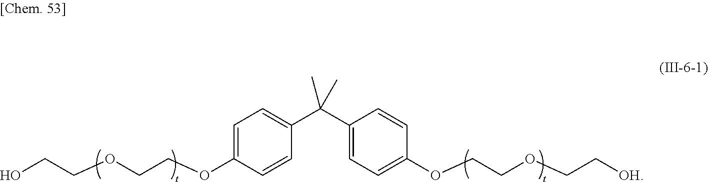

According to one embodiment, the at least one polyol (III) is such that L2 represents L2-7. According to this embodiment, R34 preferably represents H, CH₃ or CH₃ (CH₂)ᵣ with r ranging from 1 to 4. According to this embodiment, u preferably represents 1, 2 or 3. As examples of polyols (III) according to this embodiment, mention can be made of the following polyols:

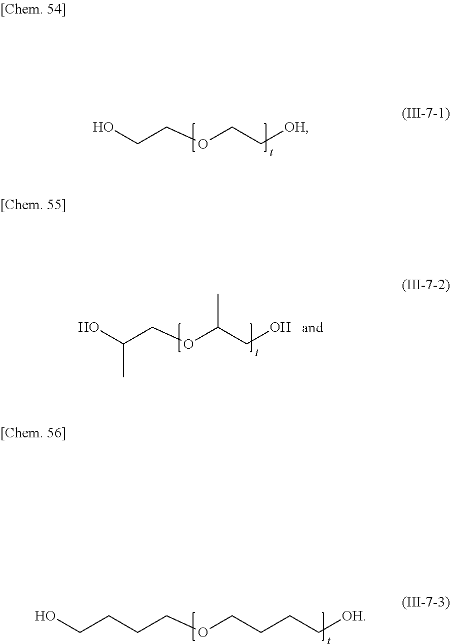

According to one embodiment, the at least one polyol (III) is such that L2 represents L2-8. Preferably according to this embodiment, r represents an integer ranging from 1 to 4, and preferably equal to 1 or 2. According to a first variant of this embodiment, R35 preferably represents CH₃ or CH₃(CH₂)ᵣ with r preferably ranging from 1 to 4, and better being equal to 1 or 2. According to a second variant of this embodiment, R35 represents HO(CH₂)ᵣ, with r representing an integer preferably ranging from 1 to 4, and in particular equal to 1 or 2. As examples of polyols (III) according to this embodiment, mention can be made of the following polyols:

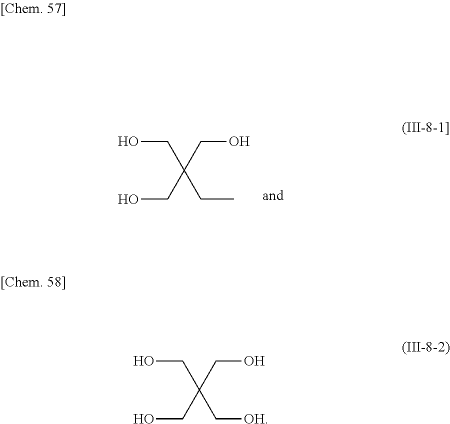

According to one embodiment, the at least one polyol (III) is such that L2 represents L2-9. According to this embodiment, R36 and R36′ are identical or different and preferably independently represent H, CH₃ or CH₃ (CH₂)ᵣ with r representing an integer ranging from 1 to 4, preferably equal to 1 or 2. As examples of polyols (III) according to this embodiment, mention can be made of the following polyols:

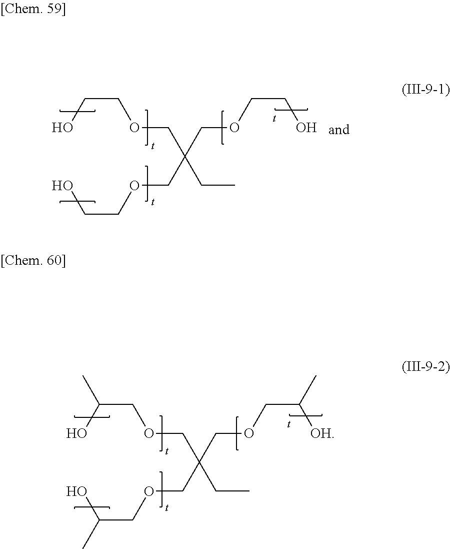

According to one embodiment, the at least one polyol (III) is such that L2 represents L2-10. According to this embodiment, R36 preferably represents H, CH₃ or CH₃(CH₂)ᵣ with r representing an integer ranging from 1 to 4, preferably equal to 1 or 2. As examples of polyols (III) according to this embodiment, mention can be made of the following polyols:

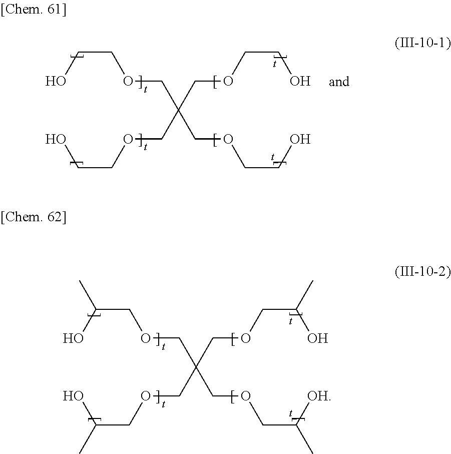

According to one embodiment, the at least one polyol (III) is such that L2 represents L2-11. According to this embodiment, r preferably represents an integer ranging from 1 to 4, and preferably equal to 1 or 2. As an example of polyol (III) according to this embodiment, mention can be made of 2,5-bis(hydroxymethyl)furan, for which r=1.

According to one embodiment, the at least one polyol (III) is such that L2 represents L2-12. According to this embodiment, u preferably represents 0 or 1. According to this embodiment, w preferably represents 0. As an example of polyol (III) according to this embodiment, mention may be made of the following polyol:

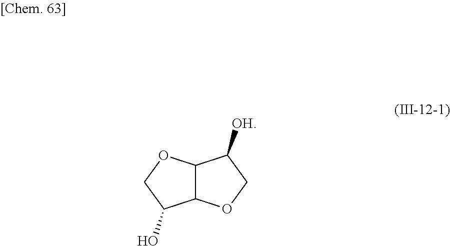

According to one embodiment, the at least one polyol (III) is such that L2 represents L2-13. According to this embodiment, r preferably represents an integer ranging from 1 to 4, preferably r is equal to 1. Preferably according to this embodiment, R37, R38, R39, R40, R41, R42, R43 and R44 independently of each other represent H, CH₃, CH₃—(CH₂)ₛ, CH₃O or CH₃—(CH₂)ₛO, and preferably H, CH₃O or CH₃—(CH₂)ₛO, with s preferably representing an integer ranging from 1 to 12, preferably from 1 to 6. According to this embodiment, R37, R38, R43 and R44 preferably represent H. According to this embodiment, R39, R40, R41 and R42 are identical or different and independently represent a group CH₃O or CH₃—(CH₂) with s preferably representing an integer ranging from 1 to 12, preferably from 1 to 6. As an example of polyols (III) according to this embodiment, mention can be made of the following polyol:

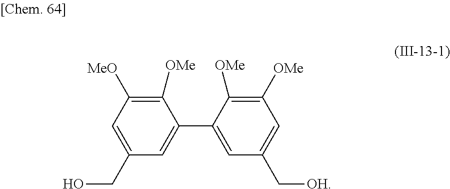 [SMILES: COc1cc(CO)cc(-c2cc(CO)cc(OC)c2OC)c1OC]

According to one embodiment, the at least one polyol (III) is such that L2 represents L2-14. According to this embodiment, R45 preferably represents H, CH₃ or CH₃(CH₂)ᵣ with r representing an integer ranging from 1 to 4, and preferably R45 represents H. According to this embodiment, R46 preferably represents (CH₂)ᵣ with r being equal to 3, 4 or 6, benzylene or cyclohexylene. According to this embodiment z is preferably equal to 0 or 1.

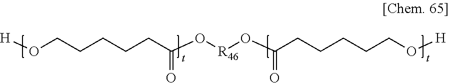

with R46=(CH₂)₃ (III-14-1)
R46=(CH₂)₄ (III-14-2)
R46=(CH₂)₆ (III-14-3)
R46=CH₂-Ph-CH₂ (III-14-4)
R46=Cy (III-14-5).

According to one embodiment, the at least one polyol (III) is such that L2 represents L2-14′. According to this embodiment, R45 preferably represents H, CH₃ or CH₃ (CH₂)ᵣ with r representing an integer ranging from 1 to 4, and preferably R45 represents CH₃ or CH₃(CH₂)ᵣ with r representing an integer ranging from 1 to 4. According to this embodiment, R46 preferably represents (CH₂)ᵣ with r being equal to 3, 4 or 6, benzylene or cyclohexylene. According to this embodiment, z preferably represents 0. As examples of polyols (III) according to this embodiment, mention can be made of the following polyols:

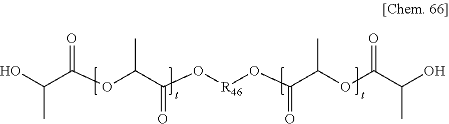

with R46=(CH₂)₃ (III-14′-1)
R46=(CH₂)₄ (III-14′-2)
R46=(CH₂)₆ (III-14′-3)
R46=CH₂-Ph-CH₂ (III-14′-4)
R46=Cy (III-14′-5)

According to one embodiment, the at least one polyol (III) is such that L2 represents L2-15. According to this embodiment, R47 and R48 are identical or different and represent H, CH₃ or CH₃(CH₂)ᵣ with r preferably representing an integer ranging from 1 to 4, preferably r being equal to 1 or 2. Preferably, z is equal to 0, 1 or 4. As examples of polyols (III) according to this embodiment, mention can be made of the following polyols:

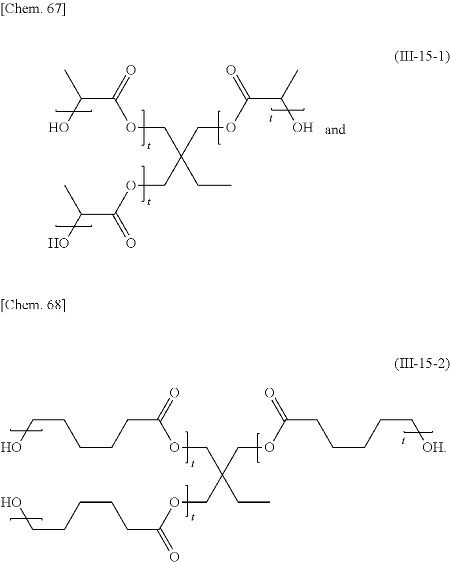

According to one embodiment, the at least one polyol (III) is such that L2 represents L2-16. According to this embodiment, R49 preferably represents H, CH₃ or CH₃ (CH₂)ᵣ with r representing an integer ranging from 1 to 4, preferably r being equal to 1 or 2. Preferably, z is equal to 0, 1 or 4. As examples of polyols (III) according to this embodiment, mention can be made of the following polyols:

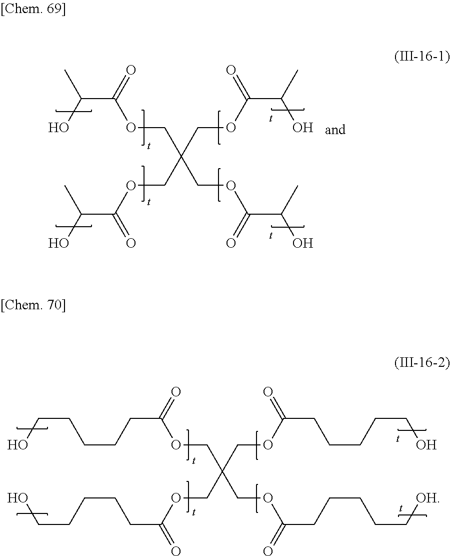

According to one embodiment, the at least one polyol (III) is such that L2 represents L2-17. According to this embodiment, L2-17 can represent a triester of hydroxylated unsaturated fatty acids, that is to say including a hydroxyl substituent on the carbon chain. According to this embodiment, the hydroxylated fatty acids are in particular selected from ricinoleic acid, lesquerolic acid or densipolic acid.

According to a preferred embodiment of the invention, the at least one polyol is such that the group L2 is selected from the groups L2-1, L2-2, L2-3, L2-4, L2-6, L2-8, L2-9 and L2-10, as defined above, and preferably from L2-8 and L2-9.

According to a particular embodiment of the invention, the polyurethane (I) is prepared from a poly oxamic acid (II) comprising two or three oxamic acid functions, and from one or two polyols (III) each comprising two, three or four hydroxyl functions, it being understood that the number of oxamic acid functions and the number of hydroxyl functions cannot both be equal to two. In other words, according to this embodiment, the polyurethane (I) is prepared from a poly oxamic acid (II) with x=2 or 3, and one or two polyols (III) such that for each y=2, 3 or 4, being understood that x and y cannot both be equal to 2.

According to a preferred embodiment of the invention, x=2 or 3 and y=2, 3 or 4, and preferably x=2 and y=3 or 4.

According to one embodiment, the at least one poly oxamic acid of formula (II) is such that the group L1 is selected from the groups L1-1, L1-1′, L1-2, L1-6, L1-9 and L1-10, as defined above, and preferably from L1-1 and L1-2, and the at least one polyol (III) is such that L2 is selected from the groups L2-1, L2-2, L2-3, L2-4, L2-6, L2-8, L2-9 and L2-10, as defined above, and preferably from L2-8 and L2-9.

According to one embodiment, the at least one poly oxamic acid of formula (II) is such that x=2 or 3 and L1 group is selected from groups L1-1, L1-2, L1-6, L1-9 and L1-10, as defined above, and preferably from L1-1 and L1-2, and the at least one polyol (III) is such that y=2, 3 or 4 and L2 is selected from groups L2-1, L2-2, L2-3, L2-4, L2-6, L2-8, L2-9 and L2-10, as defined above, and preferably from L2-8 and L2-9, with the understanding that x and y are not both equal to 2.

The reaction in step a) is carried out in the presence of an oxidant. Among the oxidants which may be suitable in the context of the invention, mention may in particular be made of hypervalent iodine oxidants such as bis(trifluoroacetoxy)iodobenzene, bis(acetoxy)iodobenzene (or iodobenzene diacetate), poly[4-(diacetoxyiodo)styrene], hydroxybenziodoxole, and acetoxybenziodoxole. Poly[4-(diacetoxyiodo)styrene](CAS number 36290-94-5, and also known as polystyrene iodoacetate) is for example marketed by the company TCI under the reference P1415. According to a preferred embodiment, the oxidant is a hypervalent iodine oxidant selected from bis(trifluoroacetoxy)iodobenzene, poly[4-(diacetoxyiodo)styrene](or polystyrene iodoacetate), and bis(acetoxy)iodobenzene (or diacetate iodobenzene). According to a first particular embodiment, the hypervalent iodine oxidant is supported, for example on a polymer, such as poly[4-(diacetoxyiodo)styrene]. According to a second embodiment, the hypervalent iodine oxidant is not supported, and is preferably selected from bis(trifluoroacetoxy)iodobenzene, and bis(acetoxy)iodobenzene.

Preferably, the molar ratio of oxidant relative to the oxamic acid functions (that is to say the ratio: number of moles of oxidant/(x*number of moles of oxamic acid)) ranges from 1 to 1.2, and preferably is equal to 1.1.

Preferably, the oxamic acid:hydroxyl functional ratio ranges from 0.8:1 to 1.3:1, preferably from 0.9:1 to 1.1:1. According to a particularly preferred embodiment, the oxamic acid:hydroxyl functional ratio is 1.1:1. Oxamic acid:hydroxyl functional ratio means the ratio between the number of oxamic acid functions of the poly oxamic acid(s) and the number of hydroxyl functions of the polyol(s). In other words, this ratio is equal to (x*number of moles of poly oxamic acid(s))/(y*number of moles of polyol(s)).

According to a particular embodiment, the reaction in step a) is carried out in the presence of a surfactant (IV). When the method is carried out in a closed reactor, the surfactant is optional, satisfactory results being obtained with or without surfactant. When the method is carried out in an open reactor, it is more advantageous for the surfactant to be present, although it is not essential.

The surfactant (IV) is preferably non-ionic. Among the nonionic surfactants which may be suitable in the context of the invention, mention may be made of silicone surfactants, and in particular those of the formulas below:

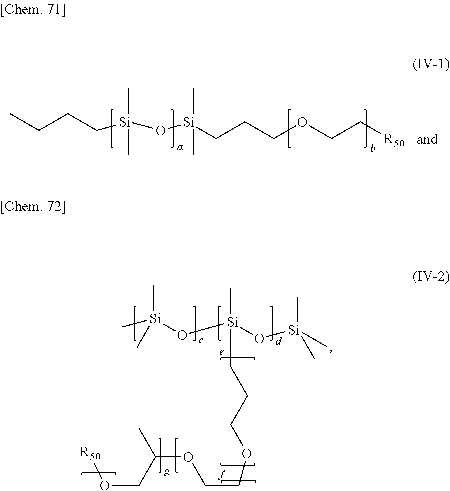

with:
   R50 representing OH, CH₃—(CH₂)ₕO or O(CO)(CH₂)ₕCH₃ with h representing an integer ranging from 0 to 3,
   a, b, c, d, e, f and g being identical or different and independently representing an integer ranging from 0 to 500, preferably from 0 to 20.

Preferably, R50 represents OH.

According to a first preferred embodiment, the surfactant is of formula (IV-2) with c=d=e=1, f=8, g=0 and R50=OH.

According to a second preferred embodiment, the surfactant is of formula (IV-2) with c=d=10, e=1, f=8, g=0 and R50=OH.

When the surfactant is present, its content is less than 4% by weight, and preferably ranges from 0.1% to 2% by weight, and preferably from 0.2 to 1% by weight, relative to the total weight of the reaction mixture.

The reaction in step a) between the at least one poly oxamic acid and the at least one polyol generates in particular carbon dioxide, which is used during the step of foaming the polyurethane (I).

Step b) of the method according to the invention allows to foam the polyurethane (I) obtained in step a).

Advantageously, the foaming step is carried out only using the carbon dioxide generated during the synthesis of the polyurethane. The carbon dioxide generated in step a) is then the foaming agent. Thus, advantageously, the synthesis of the polyurethane (step a)) and the foaming step (step b)) can be carried out concomitantly.

An optional step c), subsequent to step b), can be carried out in order to purify the polyurethane foam (I) obtained by eliminating reaction by-products. For this purpose, the polyurethane foam can be heated and/or put under reduced pressure, using a vacuum oven for example. When this step is carried out, the foam is preferably heated to a temperature ranging from 60° C. to 150° C., preferably from 80° C. to 130° C., and/or placed under reduced pressure. This step is not obligatory.

The invention also relates to the polyurethane foam (I) obtained according to the method of the invention. This foam advantageously has physicochemical properties comparable to those obtained by methods described in the prior art.

In particular, the polyurethane foam (I) can have a density ranging from 10 to 1000 kg·m⁻³ preferably from 100 to 300 kg·m⁻³. The density d corresponds to the apparent density of the foam, that is to say the ratio of the mass m and the apparent volume V of the foam. The mass m can be measured with a balance and the apparent volume V can be determined by measuring the dimensions of the foam with a caliper.

The resulting polyurethane foam has a porous structure. The cells (or pores) of polyurethane foam can have a diameter comprised between 0.1 mm and 2 mm, preferably between 0.2 mm and 1.5 mm, the diameter being measured using a scanning electron microscope at 50 Pa and 7.00 kV on sections transverse to the direction of expansion of the material. The cells or pores of polyurethane foam correspond to the empty spaces in the foam.

### EXAMPLES

Nine polyurethane foams according to the invention, PU1 to PU9, were prepared according to the following methods.

### Method for the Synthesis of Poly Oxamic Acids:

To a solution of amine (10 mmol) in dichloromethane (concentration: 0.3M) was added triethylamine (11 mmol) at room temperature. The solution was then cooled to 0° C. and then ethyl oxalyl chloride (11 mmol) was added dropwise. The solution was then slowly brought back to room temperature over a period of 4 to 6 hours while being kept stirring. The reaction was then treated with hydrochloric acid solution (1 M, 20 mL) then extracted with dichloromethane (3×20 mL). The organic phases were combined then washed with saturated sodium chloride solution. The resulting organic phase was then dried over sodium sulfate, filtered then concentrated under reduced pressure. The residue obtained was dissolved in a mixture of tetrahydrofuran (15 mL) and water (5 mL). Lithium hydroxide was then added to the solution (50 mmol). After 6 to 8 h of stirring, the solution was washed with dichloromethane (3×30 mL). The aqueous phase was then acidified with HCl solution (1 M). The mixture obtained was extracted with ethyl acetate (3×30 mL). The resulting organic phase was washed with a saturated NaCl solution (30 mL) then dried over Na₂SO₄. The solvent was then evaporated under reduced pressure and the residue was recrystallized in a mixture of dichloromethane and hexane to obtain the desired product.

### Method for Synthetizing Polyurethane in an Open Reactor:

The polyol(s) and the surfactant were introduced into an open reactor. The oxidant and poly oxamic acid were ground and mixed together in a separate reactor, and then introduced into the reactor containing the polyol(s). The reaction mixture was mixed using a spatula then by magnetic stirring. The reactor was heated to a temperature of 80° C., 100° C., 115° C. or 130° C., depending on the reagents. The reaction mixture was stirred once the reaction mixture reached a homogeneous liquid state and foam began to form. When the height of the foam was stable, it was cooked for 2 hours at this temperature. Once the cooking was finished, the reactor was cooled to room temperature (RT). The foam is then placed in a vacuum oven at 60° C. for 5 hours.

### Method for Synthetizing Polyurethane in a Closed Reactor:

The polyol(s) and the surfactant were introduced into a closed reactor. The oxidant and poly oxamic acid were ground and mixed together in a separate reactor, and then introduced into the reactor containing the polyol(s). The reaction mixture was mixed using a spatula then by magnetic stirring. The reactor was closed then heated to a temperature of 100° C. The reaction mixture was stirred once the reaction mixture reached a homogeneous liquid state. When the viscosity of the reaction mixture became high, the reactor was opened. The foam obtained was subjected to a dynamic vacuum for 5 minutes, then was cooked for 2 hours at 100° C. under static vacuum. After the cooking was completed, the reactor was cooled to room temperature (RT) before opening. The foam is then placed in a vacuum oven at 60° C. for 5 hours.

The compositions of polyurethane foams are detailed in Table 1 below. The percentages are mass percentages relative to the total weight of the reagents in the reaction mixture. The ethoxylated trimethylol propane used has a number average molar mass Mn of 1014 g·mol⁻¹.

TABLE 1

| | | PU1 | PU2 | PU3 | PU4 | PUS | PU6 | PU7 | PU8 | PU9 |
|---|---|---|---|---|---|---|---|---|---|---|
| | | m (g) | m (g) | m (g) | m(g) | m(g) | m(g) | m(g) | m(g) | m(g) |
| | | % | % | % | % | % | % | % | % | % |
| Polyol | Ethoxylated trimethylolpropane | 1.217 g | 0.730 g | 0.243 g | 1.217 g | 1.217 g | 1.217 g | 1.217 g | 1.217 g | 1.217 g |
| | (CAS 50586-59-9) | 38.4% | 26.8% | 10.6% | 38.4% | 37.1% | 37.1% | 38.4% | 38.4% | 38.4% |
| | Pentaerythritol | — | 0.049 g | 0.098 g | — | — | — | — | — | — |
| | (CAS 115-77-5) | — | 1.8% | 4.3% | — | — | — | — | — | — |
| Poly | 2.2'-(hexane-1,6-diylbis | 0.521 g | 0.521 g | 0.521 g | 0.521 g | — | — | 0.521 g | 0.521 g | 0.521 g |
| oxamic | (azanediyl))bis(2-oxoacetic) | 16.5% | 19.1% | 22.7% | 16.5% | | | 16.5% | 16.5% | 16.5% |
| acid | acid | | | | | | | | | |
| | 2.2'-(decane-1,10- | — | — | — | — | 0.633 g | — | — | — | — |
| | diylbis(azanediyl)bis | | | | | 19.3% | | | | |
| | (2-oxoacetic) acid | | | | | | | | | |
| | 2-(((5-(carboxyformamido)- | — | — | — | — | — | 0.629 g | — | — | — |
| | 1,3,3-trimethylcyclohexyl) | | | | | | 19.2% | | | |
| | methyl)amino)-2- | | | | | | | | | |
| | oxoacetic acid | | | | | | | | | |
| oxydant | iodobenzene diacetate | 1.417 g | 1.417 g | 1.417 g | 1.417 g | 1.417 g | 1.417 g | 1.417 g | 1.417 g | 1.417 g |
| | | 44.7% | 52% | 61.9% | 44.7% | 43.2% | 43.3% | 44.7% | 44.7% | 44.7% |
| surfactant | Ethoxylated | 0.012 g | 0.008 g | 0.012 g | 0.012 g | 0.012 g | 0.012 g | 0.012 g | 0.012 g | — |
| | poly(dimethylsiloxane) | 0.4% | 0.3% | 0.5% | 0.4% | 0.4% | 0.4% | 0.4% | 0.4% | |
| | (CAS 67674-67-3) | | | | | | | | | |
| | Ethoxylated poly | — | — | — | — | — | — | — | — | 0.012 g |
| | (dimethylsiloxane) | | | | | | | | | 0.4% |
| | (CAS 68937-54-2) | | | | | | | | | |
| | Temperature (° C.) | 115 | 100 | 100 | 100 | 100 | 100 | 130 | 80 | 100 |
| | Reactor | ouvert | ouvert | ouvert | fermé | ouvert | ouvert | ouvert | ouvert | ouvert |
| | oxamic acid:hydroxyl | 1.1:1 | 1.1:1 | 1.1:1 | 1.1:1 | 1.1:1 | 1.1:1 | 1.1:1 | 1.1:1 | 1.1:1 |
| | functionnal ratio | | | | | | | | | |

The physicochemical characteristics of the nine polyurethane foams were evaluated, and are detailed in Table 2 below. The foaming time TM corresponds to the formation and stabilization time of the foam, that is to say the time from which the maximum height of foam in the reactor is obtained. The density d corresponds to the apparent density of the foam, that is to say the ratio of the mass m and the apparent volume V of the foam. The mass was measured with a balance and the apparent volume V was determined by measuring the dimensions of the foam with a caliper. The glass transition temperature Tg was measured by DSC, using an apparatus DSC Q100 from TA Instruments. For each polyurethane foam, two heating cycles from −75° C. to 200° C., with a ramp of 10° C.min⁻¹, were carried out. The glass transition temperature was determined from the second cycle. The degradation temperature T_{d5%} corresponds to the temperature at which the polyurethane foam loses 5% of its initial mass. The degradation temperature T_{d5%} was determined by thermogravimetric analysis (TGA), carried out on an apparatus TGA-Q500 from TA Instruments, under a dinitrogen atmosphere, by heating at 10° C.min⁻¹ from ambient temperature to 600° C. The mechanical properties are determined in compression by DMA, using an apparatus DMA Q850 from TA Instruments, by measuring the stress allowing 50% deformation to be reached relative to the initial height of the samples, with a prestress of 0.02 N and a ramp of 100%/min. The morphologies of the foam cells are evaluated using a scanning electron microscope (SEM) FEI QUANTA 200 at 50 Pa and 7.00 kV on sections transverse to the direction of expansion of the material. Cell diameters are measured using ImageJ software and averaged for a minimum of 100 cells per sample.

TABLE 2

| | | | | | Stress | Cell |
|---|---|---|---|---|---|---|
| | TM | d | T_{g} | T_{d5%} | _{50%} | diameter |
| | (s) | (kg m⁻³) | (° C.) | (° C.) | (kPa) | (mm) |
| PU1 | 240 | 165 | −45.4 | 292 | 3.4 | 0.75 |
| PU2 | 360 | 214 | −35.9 | 247 | 7.6 | 0.37 |
| PU3 | 550 | 223 | −14.8 | 209 | 23.3 | 0.39 |
| PU4 | 295 | 318 | −44.9 | 288 | 89.4 | 0.33 |
| PU5 | 260 | 152 | −47.6 | 282 | 7.8 | 1.23 |
| PU6 | 720 | 213 | −33.2 | 277 | 2.2 | 0.85 |
| PU7 | 180 | 156 | −44.8 | 292 | 3.9 | 0.75 |
| PU8 | 1120 | 272 | −45.4 | 274 | 9.7 | 0.26 |
| PU9 | 495 | 112 | −46.8 | 282 | 0.9 | 0.90 |

The physicochemical characteristics of the new polyurethane foams are comparable to those of flexible foams synthesized by the addition of water in a conventional isocyanate-alcohol formulation.

The Tg measured range from −33.2° C. to −47.6° C. except for PU3, which is comparable to what has been described in the literature for polyurethane foams synthesized from a propylene glycol and toluene diisocyanate in the presence of a silicone surfactant (Armistead and al., Journal of Applied Polymer Science, 1988, Vol. 35, pp. 601-629). Synthesis in an open or closed reactor has no influence on the Tg of the foam obtained.

The measured densities range from 112 kg·m⁻³ to 318 kg·m⁻³. Densities of the same order of magnitude have been reported in the literature for polyurethane foams synthesized from trifunctional propylene glycol and a mixture of 4,4′-diphenylmethylene diisocyanate (MDI) and toluene diisocyanate (TDI), in the presence of a silicone surfactant (Gwon and al., International Journal of Precision Engineering And Manufacturing, 2015, Vol. 16, No. 11, pp. 2299-2307).

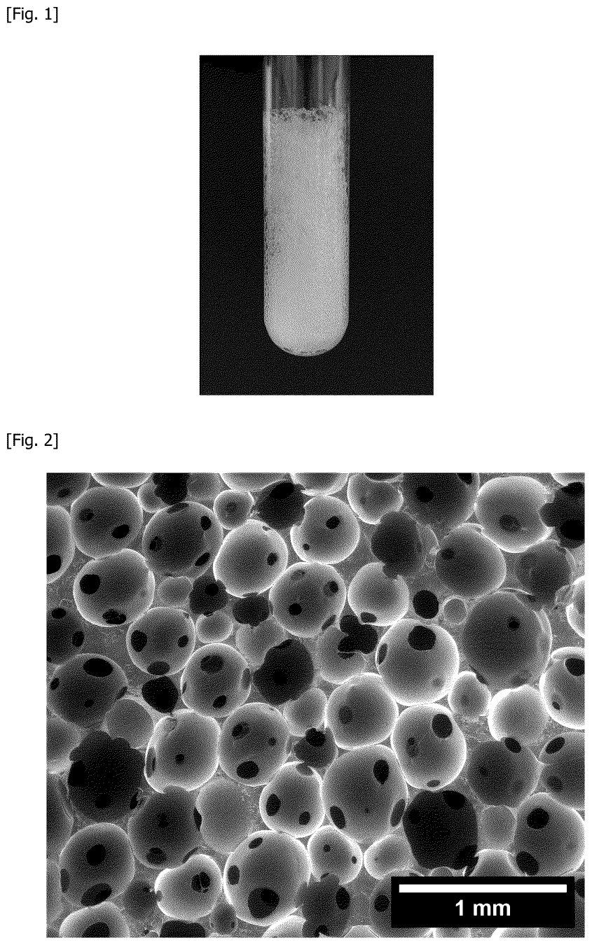

The cell diameters of PU1 to PU9 foams range from 0.26 mm to 1.23 mm, which is of the same order of magnitude as described in the literature (Gwon and al., International Journal of Precision Engineering And Manufacturing, 2015, Vol. 16, No. 11, pp. 2299-2307, Yi and al, Journal of Applied Polymer Science 2020, 137 (46). DOI: 10.1002/app49510). FIG. 1 is a photograph of PU2 allowing the macroscopic appearance of the foam formed to be visualized. FIG. 2 shows the porous structure of PU2 foam observed under a scanning electron microscope.

The stress allowing 50% deformation to be achieved relative to the initial height of the samples (stress _{50%}) for foams prepared in an open reactor ranges from 0.9 kPa to 23.3 kPa, which is comparable to what is described in Yi and al. for a deformation of 10%. For PU4 prepared in a closed reactor, the stress _{50%} was measured at 89.4 kPa.

The method according to the invention therefore allows to obtain foams having properties comparable to those obtained by decarboxylation of isocyanate in the presence of water (that is to say one of the usual foaming methods for polyurethane foams).

1. A method for preparing a polyurethane foam (I) characterized in that it comprises:
a) reacting, in the presence of an oxidant and at a temperature ranging from 60 to 150° C., at least one poly oxamic acid of formula (II): 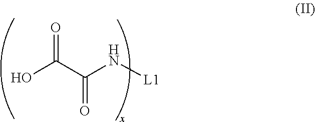
with at least one polyol of formula (III): 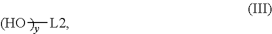
to generate in situ carbon dioxide and at least one polyisocyanate,
in which:
the oxidant is a hypervalent iodine compound,
L1 represents a saturated, linear or branched, cyclic or acyclic hydrocarbon group in which one or more CH₂ have optionally been replaced by O and/or S; or an unsaturated, linear or branched hydrocarbon group including at least one double bond and/or at least one aromatic ring optionally substituted by one or more alkyl and/or alkoxy groups; or a saturated, linear or branched, cyclic or acyclic hydrocarbon group comprising one or more COOH or polyethylene glycol substituents; or a triester of fatty acids of which one or more CH₂ have optionally been replaced by O and/or S,
L2 represents a saturated, linear or branched, cyclic or acyclic hydrocarbon group in which one or more CH₂ have optionally been replaced by O; or an unsaturated, linear or branched hydrocarbon group in which one or more CH₂ have optionally been replaced by O and including at least one aromatic ring optionally substituted by one or more alkyl and/or alkoxy groups or at least one aromatic heterocycle; or a triester of fatty acids; or a di, tri or tetra polyester of polyalkylene glycol,
x represents an integer greater than or equal to 2, and
y represents an integer greater than or equal to 2,
it being understood that at least one of x or y is greater than or equal to 3, and
b) foaming the polyurethane (I) obtained in step a) in the presence of carbon dioxide.

2. The preparation method according to claim 1, wherein the carbon dioxide used for foaming in step b) is entirely generated in step a).

3. The preparation method according to any one of the preceding claims wherein steps a) and b) are carried out concomitantly.

4. The preparation method according to any one of the preceding claims according to which L1 is selected from the following groups: 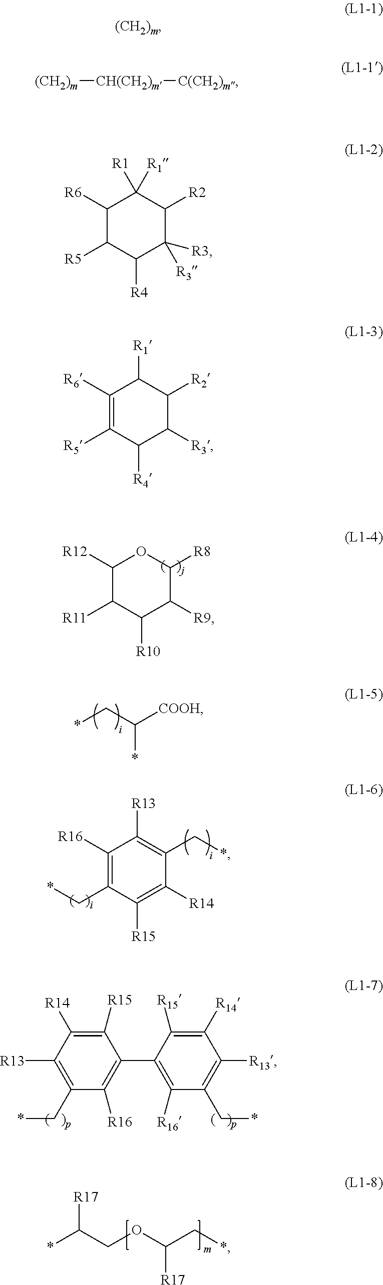 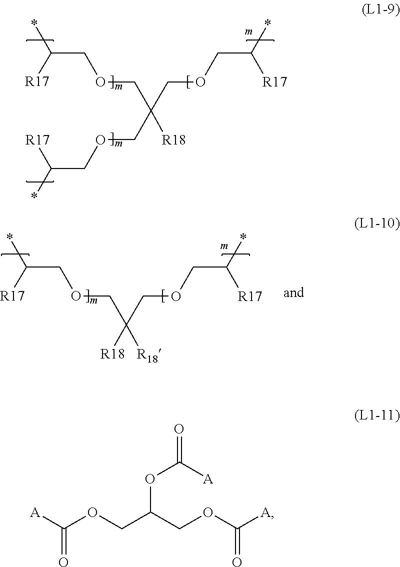
with:
R1, R1′, R1″, R2, R2′, R3, R3′, R3″, R4, R4′, R5, R5′, R6 and R6′ identical or different and independently representing H, (CH₂)ᵢ, CH₃, CH₃—(CH₂)ᵢ, CH₃O, CH₃—(CH₂)ᵢO, CH₃S, CH₃—(CH₂)ᵢS, (CH₂)ᵢS, (CH₂)ᵢCH(CH₃)S or CH₃—(CH₂)ᵢCH(CH₃)S,
R2 and R3 which can together represent a CH(R7a)-CH(R7b)-CH(R7c)-CH(R7d) group with R7a, R7b, R7c and R7d identical or different and independently representing H, (CH₂)ᵢ, CH₃, CH₃—(CH₂)ᵢ, CH₃O or CH₃—(CH₂)ᵢO,
it being understood that at least two groups among R1, R1″, R2, R3, R3″, R4, R5 and R6 and at least two groups among R1′, R2′, R3′, R4′, R5′ and R6′ represent (CH₂)ᵢ,
R8, R9, R10, R11 and R12 identical or different and independently representing H, (CH₂)ᵢ, CH₃, CH₃—(CH₂)ᵢ, O(CH₂)ᵢ, CH₃O or CH₃—(CH₂)ᵢO,
R11 and R12 which together can represent a O—CH(R7a)-CH(R7b)-CH(R7c)-(CH(R7d))ⱼ group, it being understood that at least two groups among R7a, R7b, R7c, R7d, R8, R9, R10, R11 and R12 represent (CH₂)ᵢ or O(CH₂)ᵢ,
R13, R14, R15, R16, R13′, R14′, R15′ and R16′ identical or different and independently representing H, CH₃(CH₂)ₖ or CH₃(CH₂)ₖO,
R17 representing H or CH₃(CH₂)ₖ,
R18 and R18′ independently representing H, CH₃(CH₂)ₖ, CH₂[OCH₂ CH₂]ₘOH, or CH₂[OCH₂CHCH₃]ₘNHCOCOOH,
A representing a hydrocarbon, linear or branched chain including from 12 to 30 carbon atoms, and of which one or more CH₂ have been replaced by S,
i representing an integer ranging from 0 to 20,
j representing 0 or 1,
k representing an integer ranging from 0 to 6,
m, m′ and m″ being identical or different and independently representing an integer ranging from 1 to 500, and
p representing an integer ranging from 1 to 6.

5. The preparation method according to any one of the preceding claims, according to which x is equal to 2 or 3.

6. The method according to any one of the preceding claims according to which L1 is selected from:

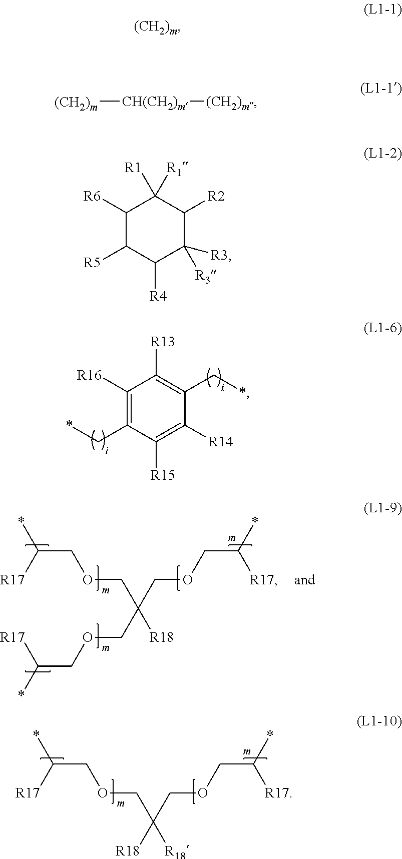

7. The method according to any one of the preceding claims, according to which L1 is selected from: (CH₂)ₘ (L1-1) and

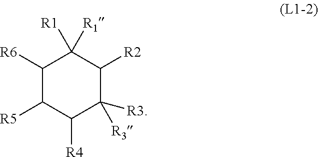

8. The preparation method according to any one of the preceding claims, according to which L2 is selected from the following groups: 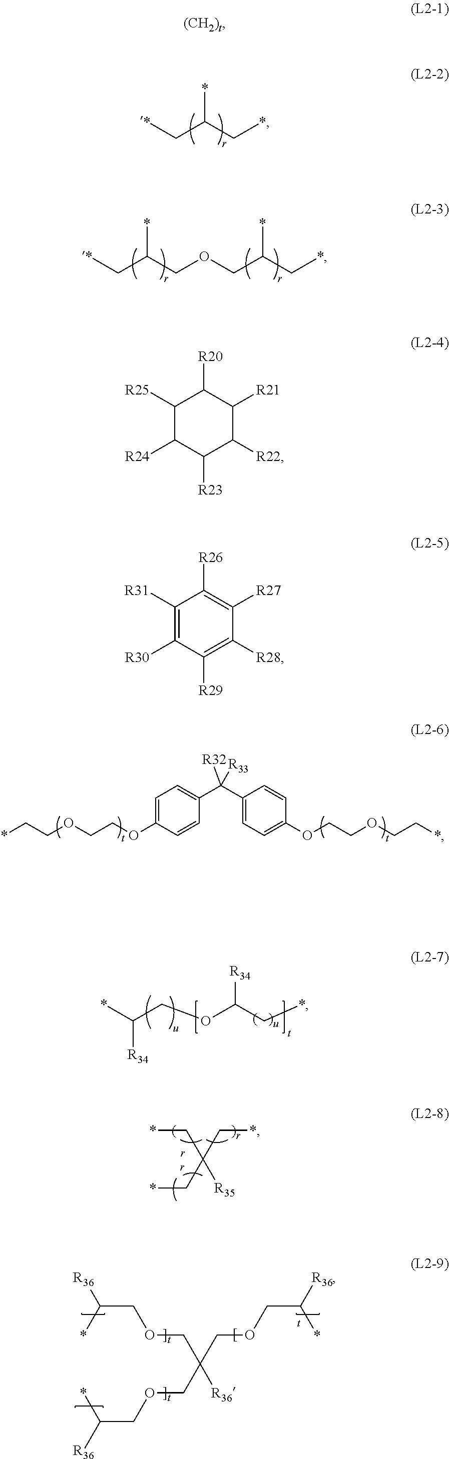 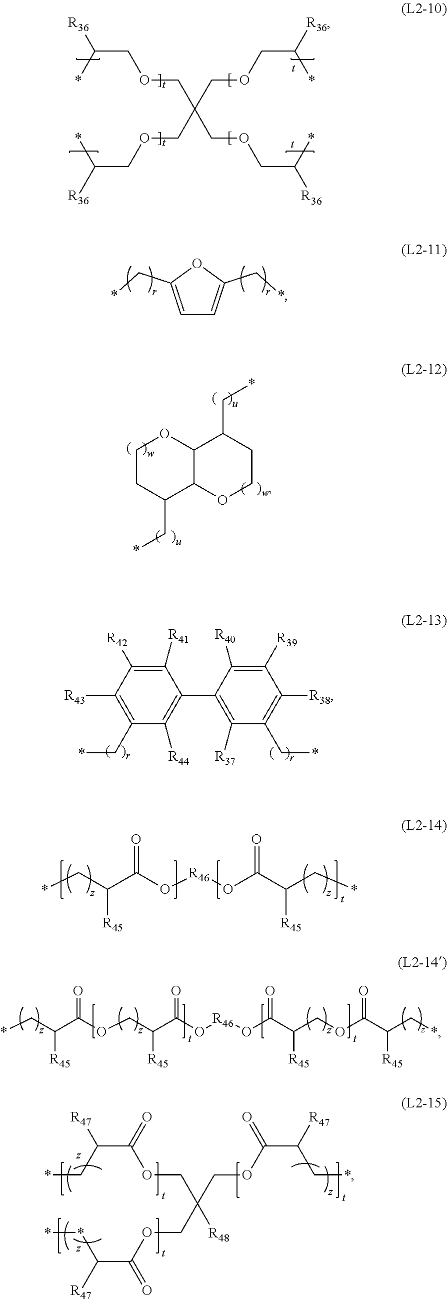 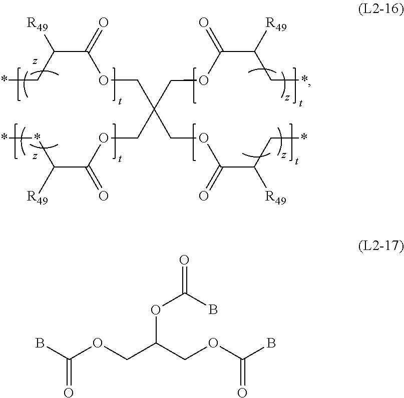
with:
20, R21, R22, R23, R24 and R25 being identical or different and independently representing H, (CH₂)ₛ, CH₃ or CH₃—(CH₂)ₛ,
R21 and R22 which can together represent a group CH(R22a)-CH(R22b)-CH(R22c)-CH(R22d) with R22a, R22b, R22c and R22d identical or different and independently representing H, (CH₂)ₛ, CH₃ or CH₃—(CH₂)ₛ,
it being understood that at least two groups among R20, R21, R22, R22a, R22b, R22c and R22d, R23, R24 and R25 represent (CH₂)ₛ,
R26, R27, R28, R29, R30 and R31 being identical or different and independently representing H, (CH₂)ₛ, CH₃, CH₃—(CH₂)ₛ, O(CH₂)ₛ, CH₃O or CH₃—(CH₂)ₛO, it being understood that at least two groups among R26, R27, R28, R29, R30 and R31 represent (CH₂)ₛ or O(CH₂)ₛ,
R32, R33, R34, R36, R36′, R45, R47, R48 and R49 independently representing H, CH₃ or CH₃(CH₂)ᵣ,
R35 representing CH₃, CH₃(CH₂)ᵣ or HO(CH₂)ᵣ,
R37, R38, R39, R40, R41, R42, R43 and R44 being identical or different and independently representing H, (CH₂)ₛ, CH₃, CH₃—(CH₂)ₛ, O(CH₂)ₛ, CH₃O or CH₃—(CH₂)ₛO,
R46 representing (CH₂)ᵣ, benzylene or cyclohexylene,
B representing a hydrocarbon, linear or branched chain including from 12 to 30 carbon atoms, and including at least one double bond,
s representing an integer ranging from 1 to 18,
r representing an integer ranging from 1 to 6,
t representing an integer ranging from 1 to 500,
u representing 0, 1, 2 or 3,
w representing 0 or 1,
z representing an integer ranging from 0 to 4.

9. The preparation method according to any one of the preceding claims, according to which y is equal to 3 or 4.

10. The method according to any one of the preceding claims according to which L2 is selected from:

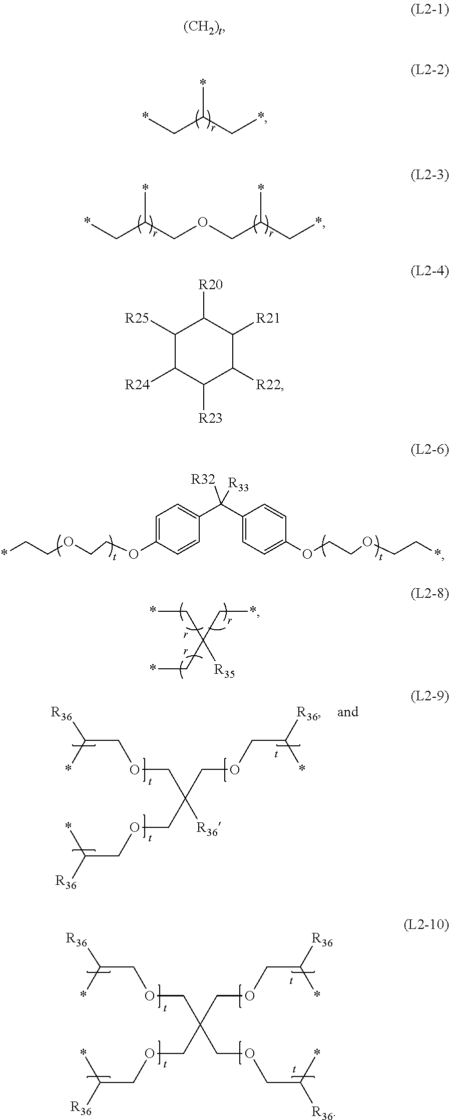

11. The method according to any one of the preceding claims according to which L2 represents:

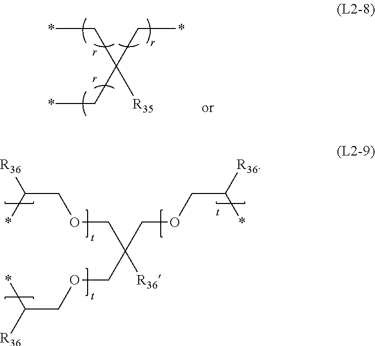

12. The preparation method according to any one of the preceding claims, according to which the oxidant is selected from bis(trifluoroacetoxy)iodobenzene, bis(acetoxy)iodobenzene, poly[4-(diacetoxyiodo)styrene], hydroxybenziodoxole, and acetoxybenziodoxole.

13. The method according to any one of the preceding claims, comprising a step c), subsequent to step b), of purifying the polyurethane foam (I), preferably by heating and/or under reduced pressure.

14. The method according to any one of the preceding claims, according to which the reaction between the at least one poly oxamic acid and the at least one polyol is carried out in the presence of a non-ionic surfactant (IV).

15. The method according to the preceding claim according to which the surfactant (IV) is selected from: 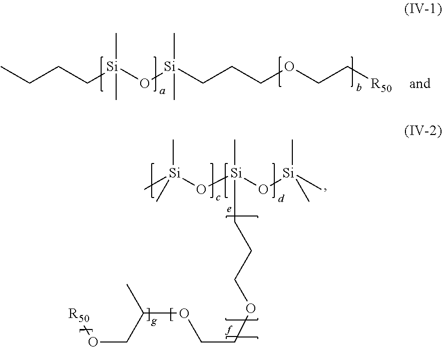
with:
R50 representing OH, CH₃—(CH₂)ₕO or O(CO)(CH₂)ₕCH₃ with h representing an integer ranging from 0 to 3,
a, b, c, d, e, f and g being identical or different and independently representing an integer ranging from 0 to 500.

16. The preparation method according to any one of the preceding claims carried out in a closed reactor and under reduced pressure.

17. The preparation method according to any one of claims 1 to 15 carried out in an open reactor.

18. The preparation method according to any one of the preceding claims, wherein the polyurethane foam (I) is purified by a heating step and/or under reduced pressure.

19. A polyurethane foam obtained according to the preparation method according to any one of the preceding claims.

20. The polyurethane foam according to the preceding claim, the density of which ranges from 10 to 1000 kg·m⁻³, preferably from 100 to 300 kg·m⁻³, the density being the ratio of the mass of the foam measured with a balance, and the apparent volume of the foam determined by measuring the dimensions of the foam with a caliper.

21. The polyurethane foam according to claim 19 or 20 having cells whose diameter is comprised between 0.1 mm and 2 mm, preferably between 0.2 mm and 1.5 mm, the diameter being measured using a scanning electron microscope at 50 Pa and 7.00 kV on sections transverse to the direction of expansion of the material.
